(19) United States
(12) Patent Application Publication
(10) Pub. No.: US 2016/0075607 A1
(43) Pub. Date: Mar. 17, 2016

(54) FERTILIZER COMPOSITIONS AND METHODS THEREOF

(71) Applicant: SAUDI BASIC INDUSTRIES CORPORATION, Riyadh (SA)

(72) Inventors: Malik AQEL, Amman (JO); Labeeb Chaudhary AHMED, Riyadh (SA); Syed Azhar HASHMI, Hyderaband (IN); Andy KELLS, Belfast (IE)

(73) Assignee: Saudi Bacsic Industries Corporation

(21) Appl. No.: 14/889,095

(22) PCT Filed: Dec. 23, 2013
(86) PCT No.: PCT/IB2013/003216

§ 371 Date: Nov. 4, 2015

Related U.S. Application Data
(60) Provisional application No. 61/819,976, filed on May 6, 2013.

(51) Int. Cl. C05B 7/00

(52) U.S. Cl. CPC C05B 7/00

(57) ABSTRACT

Disclosed herein are fertilizer compositions comprising: a fertilizer comprising a nitrogen compound, a phosphorus compound, and a potassium compound. The fertilizer composition also comprises a filler. Also, disclosed are the methods of making and methods of using the fertilizer compositions.

### CROSS-REFERENCE TO RELATED APPLICATIONS

This Application claims the benefit of U.S. Provisional Application No. 61/819,976, filed on May 6, 2013, which is incorporated herein by reference in its entirety.

### BACKGROUND

Plant mineral nutrition arts are influenced by both fundamental botanic processes and production economies of scale. Plants obtain most of their nutrients by slow extraction of minerals that contain the necessary materials from soil or water. Plants need macronutrients in large amounts, such as salts containing phosphorus (P), potassium (K), and calcium (Ca), can be sourced by natural extraction of terrestrial minerals and, for nitrogen (N), molecular nitrogen (N₂) can be sourced from the atmosphere. These natural supply and demand cycles of absorption and desorption of plant nutrients, however, can be too slow to accommodate an increasing demand in agribusiness for availability of product for human and animal consumption.

A goal of modern farming is procurement of maximum product per unit area of land by planting the same crops in the same ground annually. However, this prohibits the ground from naturally replenishing the minerals necessary for plant growth. Current agricultural practice, applies plant mineral nutrition, such as, for example, chemical fertilizers, at high rates. The fertilizers deliver macronutrients, as well as micronutrients, such as iron, copper, zinc, and manganese, that are needed in smaller amounts and are readily available, through controlled and efficacious delivery, to plants. Moreover, when chemical fertilizers are applied repeatedly it is important to modulate accumulation of excess or undesired ingredients, for example, chloride ions, in the surroundings. Low chloride fertilizers are also necessary for application to chloride-sensitive crops, such as tobacco, potatoes, or grapes, as well as for plant germination and foliage spraying.

There is, therefore, an existing need in the plant mineral nutrition arts for development of fertilizers that do not rely on a chloride ion for efficacy, that have an appropriate macronutrient and, optionally, micronutrient content, and that have desirable and predictable physical and delivery properties.

### SUMMARY

In accordance with the purposes of the present invention, as embodied and broadly described herein, the invention, in one aspect, relates to a fertilizer composition comprising:
a) a fertilizer comprising a nitrogen compound, a phosphorus compound, a sulfur compound, and one or more potassium compounds, wherein one of the one or more potassium compounds is potassium oxide, and
b) a filler, wherein the filler comprises single superphosphate or triple superphosphate or a combination thereof.

Also disclosed herein is a fertilizer composition comprising:
a) a fertilizer comprising one or more nitrogen compounds, one or more phosphorus compounds, a sulfur compound, and one or more potassium compounds, wherein one of the one or more potassium compounds is potassium oxide; wherein one of the one or more nitrogen compounds is ammonium sulfate; and wherein one of the one or more phosphorus compounds is mono-ammonium phosphate (MAP); and
b) a filler.

Also disclosed herein is a fertilizer composition comprising:
a) a fertilizer comprising a nitrogen compound, a phosphorus compound, a sulfur compound, and one or more potassium compounds, wherein one of the one or more potassium compounds is potassium nitrate, and
b) a filler, wherein the filler comprises gypsum.

In an even further aspect, the present invention relates to a method for producing a fertilizer composition comprising ammonium sulfate comprising:
a) supplying a mixture of sulfuric acid and phosphoric acid; and
b) adding ammonia and phosphate rock to the mixture, thereby forming single superphosphate or triple superphosphate or a combination thereof and in-situ ammonium sulfate.

Also disclosed herein is a method for producing a fertilizer composition comprising ammonium sulfate comprising:
a) supplying a mixture of sulfuric acid and phosphoric acid; and
b) adding ammonia to the mixture, thereby forming mono-ammonium phosphate (MAP) and in-situ ammonium sulfate.

Also disclosed herein is a method for preparing a fertilizer composition comprising:
a. providing a fertilizer comprising a nitrogen compound, a phosphorus compound, a sulfur compound, and one or more potassium compounds, wherein one of the one or more potassium compounds is potassium nitrate,
b. adding a filler to the fertilizer, wherein the filler comprises gypsum, to form the fertilizer composition.

Also disclosed herein is a method of using any of the fertilizer compositions disclosed herein, comprising contacting the fertilizer composition with a plant or soil.

While aspects of the present invention can be described and claimed in a particular statutory class, such as the system statutory class, this is for convenience only, and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Additional advantages of the present invention will be set forth, in part, in the description which follows and, in part, will be obvious from the description or can be learned by practice of the present invention. The advantages of the present invention will be realized and attained by means of the elements and combinations particularly pointed out in the appended claims. It is to be understood that both the foregoing general description and the following detailed description are exemplary and explanatory only and are not restrictive of the present invention, as claimed.

### DETAILED DESCRIPTION

The present invention can be understood more readily by reference to the following detailed description of the invention and the examples included therein.

Before the present fertilizer compositions, articles, systems, devices, and/or methods are disclosed and described, it is to be understood that they are not limited to specific methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

### A. Definitions

As used herein, nomenclature for compounds and fertilizer compositions can be given using common names as well as names assigned by the International Union of Pure and Applied Chemistry (IUPAC), Chemical Abstracts Service (CAS) recommendations for nomenclature, and the Manual for Determining the Physical Properties of Fertilizer, hereby incorporated herein by reference. One of skill in the art can readily ascertain the structure of a compound and fertilizer composition if given a name by systemic reduction of the compound structure using naming conventions.

As used in the specification and the appended claims, the singular forms “a,” “an,” and “the” include plural referents unless the context clearly dictates otherwise.

As used herein, the terms “phosphoric acid” and “‘merchant grade’ phosphoric acid” mean a mixture comprising anhydrous phosphoric acid, aqueous (or hydrated) phosphoric acid (H₃PO₄), orthophosphate, and polyphosphate in water, the relative proportions of each of which can change depending on factors such as the amount of water present, the amount of each species present, and the heat of reaction.

As used herein, the term “micronutrient” means a botanically acceptable salt, such as a sulfate salt, of iron (Fe³⁺), copper (Cu²⁺), manganese (Mn²⁺), and zinc (Zn²⁺).

As used herein, the term “DAP-based” means a fertilizer composition comprising diammonium phosphate as an ammoniacal (i.e., from NH⁴⁺) nitrogen source.

As used herein, the term “MAP-based” means a fertilizer composition comprising monoammonium phosphate as an ammoniacal nitrogen source.

Ammoniacal nitrogen content is usually lower for MAP-based fertilizers that for DAP-based fertilizers.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component denotes the weight relationship between the element or component and any other elements or components or article for which a part by weight is expressed. Thus, in a composition comprising two parts by weight of component X and five parts by weight component Y, X and Y are present at a weight ratio of 2:5 or 2/5 or 0.4, and are present in such ratio regardless of whether additional components are contained in the compound. Additionally, references in the specification and concluding claims to molar ratios of a particular element or component denotes the molar relationship between the element or component and any other elements or components in the composition or article for which a molar ratio is expressed. Thus, in a composition containing five moles of component X and two moles component Y, X and Y are present at a molar ratio of 5:2 or 5/2 or 2.5 and are present in such ratio regardless of whether additional components are contained in the composition.

A weight percent (wt %) of a component, unless specifically stated to the contrary, is based on total weight of the formulation or composition in which the component is included.

As used herein, the terms “optional” or “optionally” means that a subsequently described event or circumstance can or cannot occur, and that the description includes instances where said event or circumstance occurs and instances where it does not.

Compounds described in the present invention can be present as solvates. In the case of the present invention, the solvent used to prepare the solvate is water, and the solvate is then often referred to as a hydrate. Compounds and fertilizer compositions can be present as hydrates, which can be obtained, for example, by crystallization from water. In this connection, one, two, three, or any arbitrary number of solvent or water molecules can combine with the compounds according to the invention to form hydrates. Unless stated to the contrary, the invention includes all such possible solvates. Hydrates of the present invention include, but are not limited to, dihydrates of calcium sulfate (gypsum) and monohydrates, tertrahydrates and heptahydrates of manganese sulfate.

It is known that chemical substances form solids which are present in different states of order which are termed polymorphic forms or modifications. Different modifications of polymorphic substances can differ greatly in their physical properties. Fertilizer compositions can comprise different polymorphic forms, with it being possible for particular modifications to be metastable. Unless stated to the contrary, the present invention includes all such possible polymorphic forms.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow, plain meaning derived from grammatical organization or punctuation, and number or type of embodiments described in the specification.

Disclosed are components to be used to prepare fertilizer compositions as well as the fertilizer compositions themselves to be used within the methods disclosed herein. These and other compounds are disclosed herein, and it is understood that when combinations, subsets, interactions, groups, etcetera, of these materials are disclosed that while specific reference of each various individual and collective combinations and permutation of these components cannot be explicitly disclosed, each is specifically contemplated and described herein. For example, if a particular fertilizer composition is disclosed and discussed and a number of modifications that can be made to a number of compounds including the fertilizer compositions are discussed, specifically contemplated is each and every combination and permutation of the composition and modifications that are possible unless specifically indicated to the contrary. Thus, if a class of compounds A, B, and C are disclosed as well as a class of fertilizer compositions D, E, and F and an example of a fertilizer composition, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using fertilizer compositions. Thus, if there are a variety of additional steps that can be performed, it is understood that each of these additional steps can be performed with any specific embodiment or combination of embodiments of the methods of the invention.

Process and physical property data for fertilizer compositions of the present invention are referred to herein throughout.

As used herein, the term “granule size” means particle diameter range of the material. Particle size affects agronomic response, granulation techniques, storage, handling, and blending properties. It was measured by sieving, a process comprising separating a mixture of granules according to size fraction. Size guide number (SGN) and uniformity index (UI) values were also determined SGN is defined as the particle size in millimeters of which 50 wt % by weight of the sample is coarser and 50 wt % finer times 100. This value was obtained from linear interpolation of size analysis results. The UI value is a ratio of the size of small particles to the size of large particles. A large UI value indicates a broad particle size distribution, and a small UI value indicates a narrow distribution (i.e., a UI of 100 would mean all of the particles have the same size.

As used herein, the term “abrasion resistance” means resistance to formation of dust and fines that result in granule-to-granule and granule-to-equipment contact. It is also useful for estimating material losses; handling, storage and application properties; and pollution control requirements. Abrasion resistance is determined by measuring the percentage of dust and fines created by subjecting a sample to abrasive-type action.

As used herein, the term “granule crushing strength” means minimum force required to crush an individual fertilizer granule. Crushing strength is useful in predicting the expected handling and storage properties of granular fertilizer compositions, as well as the pressure limits applied during bag and bulk storage. The crushing strength is measured by applying pressure to granules of a specified range and recording the pressure required to fracture them.

As used herein, the term “bulk density (loose)” means mass per unit volume of a material after it has been poured freely into a container under clearly specified conditions. Bulk density is a measure of the material density, material porosity, and voids between the particles of a material. Loose-pour density represents minimum density (greatest volume occupancy) expected from a given material.

As used herein, the term “critical relative humidity,” abbreviated CRH, is the atmospheric humidity above which a fertilizer composition will absorb a significant amount of moisture and below which it will not absorb a significant amount of moisture. For every fertilizer composition, there is a maximum relative humidity to which it can be exposed without absorbing moisture from the air. This value also indicates a degree of protection required during handling. The procedure for determination of CRH involved exposure of a sample of a fertilizer composition of the present invention to progressively higher relative humidity in a variable humidity chamber. The lowest humidity that initiated significant moisture pickup determined by frequent weighing of the sample was the CRH.

As used herein, the term “hydroscopicity” means the degree to which a material will absorb moisture from the atmosphere. Hydroscopicity of fertilizer compositions can determine conditions under which a bulk granular fertilizer pile can be stored and also flowability during handling and field application. Fertilizers vary in their ability to withstand physical deterioration, such as wetting and softening, when exposed to humidity. Even fertilizers with similar CRH values can behave differently as a result of differences in moisture holding capacity. Thus, CRH alone is not sufficient to determine hydroscopicity of a fertilizer composition. Accordingly, hydroscopocities of fertilizer compositions can be compared by imposing various periods of humid exposure on samples contained in completely filled, open-top glass cups. The hydroscopicity tests consisted of moisture absorption, which is rate of moisture pickup per unit of exposed surface; moisture penetration, which is depth of moisture penetration or visible wetting of the fertilizer; moisture holding capacity, which is amount of moisture that individual granules will absorb before allowing moisture to be transferred by capillary action to adjacent particles; and integrity of wetted granules, which is determined quantitatively by handling the top surface layer of a sample after it has been exposed to a humid atmosphere. Granule strength is then rated as “excellent,” “good,” “fair,” or “poor.”

As used herein, the term “flowability” means ability of fertilizer compositions to remain flowable under humid conditions. Flowability is important when considering the movement of material in conveyer systems and fertilizer applications.

### B. Fertilizer Composition

a. Overview

As used herein, “fertilizer composition” is synonymous with “composition.” The fertilizer can comprise a nitrogen compound, a phosphorus compound, a sulfur compound, and a potassium compound. These four compounds can be four separate compounds or less than four compounds where more than one of the nitrogen, phosphorus, sulfur, and/or potassium elements are contained in a single compound. In one aspect, potassium nitrate is not considered the nitrogen compound.

In one aspect, the fertilizer is made of granules that contain plant nutritive materials which, in turn, comprise a composition comprising a nitrogen (N) source, a phosphorus (P) source, a potassium (K) source, and a sulfur (S) source. Many fertilizers, such as those used by homeowners to fertilize lawns, and by farmers to grow crops, also contain chloride (Cl) ions that are carried through to the final products from source materials, such as potassium chloride (KCl), that are used in their manufacture because they consistently provide smooth, round granules with physical properties that are desirable for routine fertilizer-related operations, such as handling, sizing, storing, transporting, stacking, mixing, elevating, or spreading. Indeed, ongoing issues in plant nutrient arts include granule decomposition due to ubiquity of a substantially large percent of fertilizer particles having irregular or jagged edges that break off during fertilizer operations and generate dust, a material that irritates exposed mucus membranes, such as those of the mouth, nose, and eye. Thus, there exists need for a balance in the plant nutrient arts between chloride-containing fertilizers that have consistently desirable physical properties, such as, for example, granule size distribution; resistance to abrasion; crushing strength; bulk density; critical relative humidity; moisture absorption and penetration; and flowability, and environmental toxicity issues that characterize its widespread use, such as chloride runoff into nearby rivers and lakes, due to the solubility of chloride salts in water.

In one aspect, the disclosed composition is a fertilizer composition comprising:
a) a fertilizer comprising a nitrogen compound, a phosphorus compound, a sulfur compound, and one or more potassium compounds, wherein one of the one or more potassium compounds is potassium oxide, and
b) a filler, wherein the filler comprises single superphosphate or triple superphosphate or a combination thereof.

In another aspect, the disclosed composition is a fertilizer composition comprising:
a) a fertilizer comprising one or more nitrogen compounds, one or more phosphorus compounds, a sulfur compound, and one or more potassium compounds, wherein one of the one or more potassium compounds is potassium oxide; wherein one of the one or more nitrogen compounds is ammonium sulfate; and wherein one of the one or more phosphorus compounds is mono-ammonium phosphate (MAP); and
b) a filler.

In yet another aspect, the disclosed composition is a fertilizer composition comprising:
a) a fertilizer comprising a nitrogen compound, a phosphorus compound, a sulfur compound, and one or more potassium compounds, wherein one of the one or more potassium compounds is potassium nitrate, and
b) a filler, wherein the filler comprises gypsum.

Fertilizer grades, such as complete fertilizer grades of the present invention, can be characterized by their nitrogen, phosphorus, and potassium (NPK) content; and these contents can be expressed as oxide forms of the element. For example, an NPK Grade 12-12-17 fertilizer means one hundred pounds of this fertilizer will have about twelve pounds of nitrogen in ammoniacal (NH₄^{|}) form, nitrate (NO₃⁻) form, or a combination thereof, as nitrogen sources, about twelve pounds of phosphorus as phosphorus pentoxide (P₂O₅) in phosphate (e.g., H₂PO₄⁻, HPO₄²⁻, or a combination thereof) form as phosphorus sources, and about seventeen pounds of potassium (K^{|}) as potassium oxide (K₂O). In one aspect, the fertilizer composition does not comprise forming a water insoluble phosphorus. Non-limiting examples of water insoluble phosphorus include barium phosphates, mercury phosphates, and lead phosphates.

To determine phosphorus content of fertilizer compositions of the present invention, fertilizer samples were first placed in water to measure the percentage of total phosphate that dissolved. This percentage is referred to as water-soluble phosphate. Water insoluble fertilizer material can be then placed in ammonium citrate solution. Then, the amount of phosphorus dissolved in a solution can be recorded as a percentage of the total phosphorus in the fertilizer composition. Phosphorus content measured using this procedure is referred herein to as citrate-soluble. The sum of the water-soluble and citrate-soluble phosphates is considered to be the percentage available to plants. Typically, the citrate-soluble component is less than the water-soluble component. Complete fertilizer grades can be further characterized by sulfur (as sulfate) content, which, in turn, originates from the total sulfate contributed by gypsum, ammonium sulfate, and sulfuric acid.

In one aspect, the sulfuric acid used herein has a concentration above 2 molar (M), 4 M, 6 M, 8 M, 10 M, 12 M, 14 M, 16 M, 18 M, 20 M, or 24 M. For example, the concentration of sulfuric acid can be from 2 M to 24 M, such as from 12 M to 24 M, or from 16 M to 20 M. In another example, the concentration of sulfuric acid can be about 18 M.

In one aspect, the composition is substantially free of sulfuric acid. In another aspect, the composition does not comprise sulfuric acid. Avoiding the use of sulfuric acid can prevent reactions between potassium nitrate and sulfuric acid. The reaction between potassium nitrate and sulfuric acid can decrease granule quality, possibly by increased agglomeration.

In one aspect, granular fertilizer compositions of the present invention comprise:
MAP-Based NPK Grade 12-12-17 fertilizer from 100 wt % crystalline AS to 100 wt % in situ AS;
DAP-Based NPK Grade 12-12-17 fertilizer from 100 wt % Crystalline AS to 100 wt % in situ AS;
MAP-Based NPK Grade 15-15-15 fertilizer from 100 wt % Crystalline AS to 100 wt % in situ AS;
DAP-Based NPK Grade 15-15-15 fertilizer from 100 wt % Crystalline AS to 100 wt % in situ AS;
MAP-Based NPK Grade 16-16-16 fertilizer from 100 wt % Crystalline AS to 100 wt % in situ AS;
DAP-Based NPK 16-16-16 Grade fertilizer from 100 wt % Crystalline AS to 100 wt % in situ AS;
MAP-Based NPK 18-18-5 Grade fertilizer from 100 wt % Crystalline AS to 100 wt % in situ AS; and
DAP-Based NPK 18-18-5 Grade fertilizer from 100 wt % Crystalline AS to 100 wt % in situ AS, each of which can further optionally comprise micronutrients.

In a further aspect, the fertilizer grades can comprise the following grades:
a. 12-12-17-7S—MgO-TE
b. 18-18-5-11S—MgO-TE
c. 15-15-15-8S—MgO-TE
d. 16-16-16-8S—MgO-TE

In another aspect, disclosed herein is a fertilizer composition comprising: a fertilizer comprising a nitrogen compound, a phosphorus compound, a sulfur compound, and one or more potassium compounds, wherein one of the one or more potassium compounds is potassium nitrate, and a filler, wherein the filler comprises gypsum.

In one aspect, the source of ammonium nitrogen and phosphorus pentoxide can be anhydrous ammonia, phosphoric acid, and/or solid monoammonium phosphate (MAP) and/or diammonium phosphate (DAP). In a further aspect, the fertilizer composition does not comprise DAP. In another aspect, the source of ammonium nitrogen and phosphorus pentoxide can be anhydrous ammonia, sulfuric acid, and/or solid ammonium sulfate. In a further aspect, the source of nitrate nitrogen and potassium oxide can be from potash.

In one aspect, the fertilizer comprises nitrogen in the range of from 10 wt % to 20 wt %; P₂O₅ in the range of from 10 wt % to 20 wt %; K₂O in the range of from 5 wt % to 18 wt %; and sulfate in the range of from 5 wt % to 15 wt %. In the fertilizer compositions, any of the inventive methods of making or using recited herein throughout this specification can be employed.

Single superphosphate is known to one skilled in the art and is a mixture comprising monocalcium phosphate (MCP) and gypsum. The chemical content in single superphosphate typically includes 7-9 wt % P, 16-20 wt % P₂O₅, 18-21 wt % Ca, and 11-12 wt % S. The pH of single superphosphate is typically <2. Single superphosphate is commercially available and typically formed from a reaction between Ca₃(PO₄)₂ (rock phosphate) and H₂SO₄ (sulfuric acid).

Triple superphosphate is known to one skilled in the art and comprises substantially only monocalcium phosphate (MCP). The chemical content in triple superphosphate typically includes 17-23 wt % P, 44-52 wt % P₂O₅, and <3 wt % S. The pH of triple superphosphate is typically 1-3. Triple superphosphate is commercially available and is typically formed from a reaction between Ca₃(PO₄)₂ (rock phosphate) and H₃PO₄ (phosphoric acid).

b. Nitrogen

In one aspect, the fertilizer composition can comprise a nitrogen compound. In one aspect, the fertilizer composition can comprise ammoniacal nitrogen or nitrate nitrogen, or a combination thereof. In another aspect, the fertilizer composition can comprise anhydrous ammonia.

In one aspect, the ammoniacal nitrogen can be added to the composition in the form of ammonium sulfate. Ammonium sulfate can introduce both nitrogen and sulfur into the soil, which can benefit plant growth. In a further aspect, the ammonium sulfate can be about 100 wt % solid ammonium sulfate formed from a reaction between ammonia and sulfuric acid. In one aspect, the nitrogen content can overlap with the other disclosed contents. For example, in some aspects, ammonium sulfate can be both a nitrogen compound and a sulfur compounds disclosed herein.

In one aspect, the fertilizer composition does not comprise a urea-based nitrogen.

In one aspect, the total nitrogen content in the fertilizer composition ranges from 5 wt % to 30 wt %, including exemplary values 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, and 29 wt %. In further aspects, the weight percentage can be in a range derived from any two of the above listed exemplary values. For example, the total nitrogen content can range from 12 wt % to 20 wt %.

In another aspect, the nitrogen content is present in the fertilizer composition in an amount ranging from 10 wt % to 20 wt %, including exemplary values 11 wt %, 12 wt %, 13 wt %, 14 wt %, 15 wt %, 16 wt %, 17 wt %, 18 wt %, and 19 wt %. In further aspects, the weight percentage can be in a range derived from any two of the above listed exemplary values. For example, the nitrogen content can range from 11 wt % to 19 wt %.

In one aspect, the fertilizer composition comprises ammoniacal nitrogen in an amount ranging from 3 wt % to 25 wt %, including exemplary values of 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, and 24 wt %. In further aspects, the weight percentage can be in a range derived from any two of the above listed exemplary values. For example, the nitrogen content can comprise ammoniacal nitrogen in an amount ranging from 6 wt % to 17 wt %.

In another aspect, the fertilizer composition comprises nitrate nitrogen in an amount ranging from 0.5 wt % to 9 wt %, including exemplary values of 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, and 8.0 wt %. In further aspects, the weight percentage can be in a range derived from any two of the above listed exemplary values. For example, the fertilizer composition comprises nitrate nitrogen in an amount ranging from 1.0 wt % to 8.0 wt %.

In one aspect, the nitrogen feed in the pipe-cross reactor can be present in an amount ranging from 500 kg/h to 410,000 kg/h, including exemplary values of 600 kg/h, 800 kg/h, 1000 kg/h, 1300 kg/h, 1500 kg/h, 2000 kg/h, 3000 kg/h, 4000 kg/h, 5000 kg/h, 6000 kg/h, 7000 kg/h, 8000 kg/h, 9000 kg/h, 10,000 kg/h, 20,000 kg/h, 30,000 kg/h, 40,000 kg/h, 50,000 kg/h, 60,000 kg/h, 80,000 kg/h, 100,000 kg/h, 150,000 kg/h, 200,000 kg/h, 250,000 kg/h, 300,000 kg/h, 350,000 kg/h, 400,000 kg/h. In further aspects, the feed can be in a range derived from any two of the above listed exemplary values. For example, the nitrogen feed can range from 500 kg/h to 8000 kg/h. In one aspect, the nitrogen in the nitrogen feed can comprise ammonia.

In another aspect, the nitrogen feed in the drum granulator can be present in an amount ranging from 100 kg/h to 3,000 kg/h, including exemplary values of 200 kg/h, 300 kg/h, 500 kg/h, 800 kg/h, 1100 kg/h, 1500 kg/h, 1800 kg/h, 2100 kg/h, 2400 kg/h, and 2700 kg/h. In further aspects, the feed can be in a range derived from any two of the above listed exemplary values. For example, the nitrogen feed in the drum granulator can be present in an amount ranging from 800 kg/h to 2,500 kg/h.

In a further aspect, using a high ratio of crystalline ammonium sulfate to in situ ammonium sulfate production allows for improved granulation process control and improved granular crushing strength. In one aspect, the ratio of crystalline ammonium sulfate to in situ ammonium sulfate can be in a range of 50% to 100%, including exemplary values of 55%, 60%, 65%, 70%, 75%, 80%, 85%, 90%, and 95%. In further aspects, the ratio can be in a range derived from any two of the above listed exemplary values. For example, the ratio of crystalline ammonium sulfate to in situ ammonium sulfate can be in a range of 30% to 70%. In situ refers to the manufacture of the product directly in the process as opposed to adding the product as a solid pre-manufactured product.

In one aspect, using low recycle ratio in the range of 1 to 4 can allow for better control on the granulation and final product crushing strength. Here, the low recycling ratio can be for the granulation seed material versus fresh feeds to the granulator.

For 12-12-17 Grades, nitrogen content comprised about 7.0 wt % to about 7.5 wt % ammoniacal nitrogen and about 4.9 wt % to about 5.2 wt % nitrate nitrogen; for 15-15-15 Grades, nitrogen content comprised about 9.7 wt % to about 10.2 wt % ammoniacal nitrogen and about 4.4 wt % to about 4.9 wt % nitrate nitrogen; for 16-16-16 Grades, nitrogen content comprised about 10.0 wt % to about 10.4 wt % ammoniacal nitrogen and about 4.8 wt %-5.3 wt % nitrate nitrogen; and for 18-18-5 Grades, nitrogen content comprised about 15.6 wt % to about 16.1 wt % ammoniacal nitrogen and about 1.6 wt % to about 2.1 wt % nitrate nitrogen.

c. Phosphorus

In one aspect, the fertilizer composition can comprise a phosphorus compound. Phosphorus content in the fertilizer compositions can comprise water-soluble or citrate-soluble phosphorus pentoxide, or a combination thereof.

The phosphorus compound can be added to the fertilizer composition in the form of diammonium phosphate (DAP) or monoammonium phosphate (MAP) or a combination thereof. The DAP or the MAP can be made directly at the manufacturing site from ammonia and phosphoric acid. In one aspect, the phosphoric acid can be merchant grade. In another aspect, the DAP or the MAP can provide high levels of water-soluble phosphorus pentoxide. The DAP or the MAP or a combination thereof can allow the phosphorus content to be available to the plant, which can benefit plant growth. In one aspect, the phosphorus content can overlap with the other disclosed contents.

In one aspect, the phosphorus compound can be added to the fertilizer composition in the form of single superphosphate (SSP) or triple superphosphate (TSP) or a combination thereof. In another aspect, the SSP or TSP can be added as a dry feed. In a further aspect, the addition of the SSP or TSP could alter the solid: liquid ratio in the granulation step. As such, the solid: liquid ratio can require adjustment to allow for the formation of granules.

In one aspect, the SSP can comprise a phosphate content of 18 wt %. In a further aspect, the TSP can comprise a phosphate content of 48 wt %. In an even further aspect, the phosphoric acid can have a phosphorus content in an amount ranging from 52 wt % to 54 wt %.

In another aspect, SSP can be used as a substitute for some NPK grades with low phosphate requirements. In a further aspect, the amount of substitution by SSP or TSP or a combination thereof that is possible can depend on the NPK grade required.

In one aspect, the fertilizer composition can comprise phosphorus pentoxide from 5 wt % to 30 wt %, including exemplary values 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %,24 wt %,25 wt %, 26 wt %, 27 wt %, 28 wt %,and29 wt %. In further aspects, the weight percentage can be in a range derived from any two of the above listed exemplary values. For example, the total phosphorus content can range from 12 wt % to 20 wt %.

In one aspect, the fertilizer composition can comprise phosphorus pentoxide from 10 wt % to 20 wt %, including exemplary values 11 wt %, 12 wt %, 13 wt %, 14 wt %, 15 wt %, 16 wt %, 17 wt %, 18 wt %, and 19 wt %. In further aspects, the weight percentage can be in a range derived from any two of the above listed exemplary values. For example, the fertilizer composition can comprise phosphorus pentoxide from 11 wt % to 19 wt %.

In another aspect, the fertilizer composition can comprise water-soluble phosphorus pentoxide in an amount ranging from 5 wt % to 20 wt %, including exemplary values 7 wt %, 8 wt %, 9 wt %, 10 wt %, 11 wt %, 12 wt %, 13 wt %, 14 wt %, 15 wt %, 16 wt %, 17 wt %, 18 wt %, and 19 wt %. In further aspects, the weight percentage can be in a range derived from any two of the above listed exemplary values. For example, the fertilizer composition can comprise water-soluble phosphorus pentoxide in an amount ranging from 8 wt % to 17 wt %.

In a further aspect, the fertilizer composition can comprise citrate soluble phosphorus pentoxide in an amount ranging from 0.5 wt % to 5 wt %, including exemplary values 1 wt %, 1.1 wt %, 1.2 wt %, 1.4 wt %, 1.5 wt %, 1.7 wt %, 2 wt %, 2.2 wt %, 2.3 wt %, 2.5 wt %, 2.7 wt %, 2.9 wt %, 3 wt %, 3.2 wt %, 3.4 wt %, 3.6 wt %, 3.8 wt %, 3.9 wt %, 4 wt %, 4.2 wt %, 4.5 wt %, and 4.7 wt %. In further aspects, the weight percentage can be in a range derived from any two of the above listed exemplary values. For example, the fertilizer composition can comprise citrate soluble phosphorus pentoxide in an amount ranging from 1.1 wt % to 3.9 wt %.

In one aspect, the phosphorus feed in the pipe-cross reactor can be present in an amount ranging from 1,000 kg/h to 15,000 kg/h, including exemplary values of 2,000 kg/h, 3,000 kg/h, 4,000 kg/h, 5,000 kg/h, 6,000 kg/h, 7,000 kg/h, 8,000 kg/h, 9,000 kg/h, 10,000 kg/h, 11,000 kg/h, 12,000 kg/h, 13,000 kg/h, and 14,000 kg/h. In further aspects, the feed can be present in a range derived from any two of the above listed exemplary values. For example, the phosphorus feed in the pipe-cross reactor can be present in an amount 1,500 kg/h to 14,500 kg/h. In one aspect, the phosphorus feed can comprise phosphoric acid, a MAP solution, a DAP solution, or a combination thereof.

For 12-12-17 Grades, phosphorus content comprised about 8.6 wt % to about 10.5 wt % water-soluble phosphorus and about 1.1 wt % to about 3.9 wt % citrate-soluble phosphorus; for 15-15-15 Grades, phosphorus content comprised about 11.4 wt % to about 13.1 wt % water-soluble phosphorus and about 1.2 wt % to about 2.5 wt % citrate-soluble phosphorus; for 16-16-16 Grades, phosphorus content comprised about 12.7 wt % to about 14.6 wt % water-soluble phosphorus and about 1.9 wt % citrate soluble phosphorus; and for 18-18-5 Grades, phosphorus content comprised about 15.8 wt % to about 16.6 wt % water-soluble phosphorus and about 2.0 wt % to about 2.3 wt % citrate-soluble phosphorus.

d. Sulfur

In one aspect, the fertilizer composition can comprise a sulfur compound. In one aspect, the amount of sulfur compound of the fertilizer compositions of the present invention can be expressed as the weight percent sulfate. For example, the fertilizer composition can comprise calcium sulfate or ammonium sulfate, or a combination thereof. In one aspect, the sulfur compound can overlap (be the same compound) as other compound in the fertilizer composition. For example, the sulfur compound can be the same as the nitrogen compound.

In one aspect, the sulfur compound in the fertilizer composition can be present as a sulfate. The sulfur compound can be present in the fertilizer composition in the range of from 5 wt % to 15 wt %, including exemplary values of 5.5 wt %, 6 wt %, 7 wt %, 8 wt %, 9 wt %, 10 wt %, 11 wt %, 12 wt %, 13 wt %, 14 wt %, and 14.5 wt % based on the total weight of the fertilizer composition. In further aspects, the weight percentage can be in a range derived from any two of the above listed exemplary values. For example, the sulfur can be present in the fertilizer composition in the range of from 5.5 wt % to 14.5 wt %.

For 12-12-17 Grades, sulfur content comprises about 6.2 wt % to about 9.0 wt %; for 15-15-15 Grades, sulfur content comprises about 6.9 wt % to about 10.2 wt %; for 16-16-16 Grades, sulfur content comprises about 6.9 wt % to 9.0 wt %; and for 18-18-5 Grades, sulfur content comprises 10.2 wt % to 12.4 wt %.

e. Potassium

In one aspect, the fertilizer composition comprises a potassium compound. In one aspect, the amount of potassium compound in the fertilizer composition can be expressed as the percent potassium oxide. In another aspect, the fertilizer composition can comprise potassium nitrate. In one aspect, the potassium compound in the fertilizer composition does not comprise potassium chloride. In another aspect, the fertilizer composition is substantially free of potassium chloride. In a further aspect, the fertilizer composition does not comprise potassium sulfate. In an even further aspect, the fertilizer composition is substantially free of potassium sulfate.

Some localities prohibit or restrict the amount of chloride ions that can be introduced into the soil. As such, for these localities, the use of potassium nitrate over potassium chloride avoids or restricts the introduction of chloride ions into the soil.

In one aspect, the fertilizer composition comprises potassium nitrate and the fertilizer composition is a granular fertilizer.

In one aspect, the fertilizer composition comprises potassium nitrate. The potassium nitrate can provide a high level of nitrogen to the plants to enhance plant growth. In a further aspect, the potassium content is highly soluble. In an even further aspect, the potassium content of the invention has a higher soluble than the solubility of a similar composition using potassium sulfate. In a yet further aspect, the potassium nitrate is more soluble than potassium sulfate, making the inventive composition more soluble than a comparative composition with potassium sulfate. The enhanced solubility can make the potassium nutrient more available to the plant, which can enhance plant growth.

In one aspect, the potassium compound in the fertilizer composition ranges from 1 wt % to 30 wt %, including exemplary values 1.5 wt %, 2 wt %, 4 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 19.5 wt %, 20 wt %, 21 wt %, 22 wt %, 23 wt %, 24 wt %, 25 wt %, 26 wt %, 27 wt %, 28 wt %, and 29 wt %. In further aspects, the weight percentage can be in a range derived from any two of the above listed exemplary values. For example, the potassium compound in the fertilizer composition can range from 1.5 wt % to 19.5 wt %.

In another aspect, the fertilizer composition comprises potassium oxide in an amount ranging from 1 wt % to 25 wt %, including exemplary values 1.5 wt %, 2 wt %, 4 wt %,5 wt %,7 wt %,8 wt %,9 wt %, 10 wt %,11wt %,12 wt %, 13 wt %,14 wt %,15 wt %, 16 wt %, 17 wt %, 18 wt %,19 wt %,20 wt %, 21 wt %,22 wt %,23 wt %, 24 wt %, and 24.5 wt %. In further aspects, the weight percentage can be in a range derived from any two of the above listed exemplary values. For example, the fertilizer composition comprises potassium oxide in an amount ranging from 1.5 wt % to 24.5 wt %.

In another aspect, the fertilizer comprises potassium oxide in an amount ranging from 5 wt % to 18 wt %, including exemplary values 6 wt %, 7 wt %, 8 wt %, 9 wt %, 10 wt %, 11 wt %, 12 wt %, 13 wt %, 14 wt %, 15 wt %, 16 wt %, and 17 wt %. In further aspects, the weight percentage can be in a range derived from any two of the above listed exemplary values. For example, the fertilizer composition can comprise potassium oxide in an amount ranging from 6 wt % to 17 wt %.

In another aspect, the potassium feed in the drum granulator can be present in an amount ranging from 1,000 kg/h to 20,000 kg/h, including exemplary values of 1,500 kg/h, 2,000 kg/h, 3,000 kg/h, 4,000 kg/h, 5,000 kg/h, 6,000 kg/h, 7,000 kg/h, 8,000 kg/h, 9,000 kg/h, 10,000 kg/h, 11,000 kg/h, 12,000 kg/h, 13,000 kg/h, 14,000 kg/h, 15,000 kg/h, 16,000 kg/h, 17,000 kg/h, 18,000 kg/h, 19,000 kg/h, 19,500 kg/h. In further aspects, the feed can be in a range derived from any two of the above listed exemplary values. For example, the potassium feed in the drum granulator can be present in an amount ranging from 1,500 kg/h to 19,500 kg/h. In one aspect, the potassium feed comprises potassium nitrate.

For 12-12-17 Grades, potassium oxide content comprised about 16.0 wt % to about 18.0 wt %; for 15-15-15 Grades, potassium oxide content comprised about 14.0 wt % to about 16.0 wt %; for 16-16-16 Grades, potassium oxide content comprised about 15.0 wt % to about 17.0 wt %; and for 18-18-5 Grades, potassium content comprised about 4.0 wt % to about 6.0 wt %.

f. Filler

In one aspect, the filler comprises gypsum. In another aspect, the filler comprises single superphosphate or triple superphosphate or a combination thereof. In a further aspect, the filler does not comprise gypsum.

In another aspect, the fertilizer composition does not comprise gypsum.

At least some of the fertilizer compositions disclosed herein comprise a phosphorus compound and a filler. In one aspect, in such compositions, the filler can be the same or different as the one or more phosphorus compounds. For example, the filler can be the same as the one or more phosphorus compounds. That is, in one aspect, the phosphorus compound acts in a fertilizer function as well as in a filler function. In another example, the filler can be different than the one or more phosphorus compound. In yet another example, a portion of the filler can include the one or more phosphorus compounds. It is understood that when the filler includes or is the one or more phosphorus compounds, that fertilizer in the fertilizer composition still comprises one or more phosphorus compounds in the fertilizer composition.

In one aspect, the filler comprises one or more phosphorus compounds. In one aspect, in fertilizers compositions comprising a filler and one or more phosphorus compounds, the filler and one or more phosphorus compounds can be the same compound(s). In another example, in fertilizers compositions comprising a filler and one or more phosphorus compounds, the filler can comprise the one or more phosphorus compounds and at least one other compound or material. In another example, in fertilizers compositions comprising a filler and one or more phosphorus compounds, the filler does not comprise the one or more phosphorus compounds.

In one aspect, the filler comprises sand, limestone, dolomite, or clay or a combination thereof. In a further aspect, the filler can comprise more than one filler. In an even further aspect, the filler can be any filler conventionally used in fertilizer compositions.

Without being bound by theory, the filler can be used to prevent over-formulation of the NPK grade. Further, the use of a filler can reduce the cost of the fertilizer, for example, by the filler being cheaper than the other ingredients of the fertilizer. In another aspect, the filler can be added as a granulation aid. As such, the filler can promote the granulation performance and can make the control of the granulation process easier. In a further aspect, a filler comprising an inert filler, such as sand, may not have a granulation enhancement affect. In an even further aspect, the filler can comprise a combination of fillers that have a balance between using the cheapest filler while maintaining the granulation process performance.

In one aspect, TSP is formed from the reaction of phosphate rock and phosphoric acid. Phosphate rock is known to one skilled in the art and substantially comprises Ca₃(PO₄)₂. Phosphate rock can also comprise impurities such as other minerals, for example, calcium carbonate or magnesium phosphate. In another aspect, the ratio between the phosphate rock to phosphoric acid is dependent on the other impurities within the phosphate rock. For example, the impurity could comprise calcium oxide which can vary from source to source or shipment to shipment depending, for example, on the natural variations in the mine. In a further aspect, the phosphoric acid to phosphate rock can be in a ratio about 2.5:1.

The calcium and/or sulfur in gypsum can be a source of desirable secondary nutrients for plants. Gypsum is known to one skilled in the art and is commercially available. It is commonly known that gypsum comprises calcium sulfate di-hydrate (CaSO₄.2H₂O).

In another aspect, the gypsum can also act as a granulation aid in the manufacturing process. In a further aspect, the gypsum, as a granulation aid, can produce hard, round granules. In a further aspect, the gypsum fill can act as a desalinating material for a saline soil.

In one aspect, the gypsum can be present in the fertilizer composition in an amount ranging from 2 wt % to 30 wt %, based on the total weight of the fertilizer composition, including exemplary values 2.5 wt %, 3 wt %, 4 wt %, 5 wt %, 6 wt %, 7 wt %, 8 wt %, 9 wt %, 10 wt %,11 wt %,12 wt %, 13 wt %,14 wt %, 15 wt %,16 wt %,17wt %, 18 wt %, 19 wt %, 20 wt %,21 wt %,22 wt %, 23 wt %,24 wt %,25 wt %, 26 wt %,27 wt %, 28 wt %, 29 wt %, and 29.5 wt %. In further aspects, the weight percentage can be in a range derived from any two of the above listed exemplary values. For example, the gypsum can be present in the fertilizer composition in an amount ranging from 2.5 wt % to 29.5 wt %.

In a further aspect, the gypsum feed in the drum granulator can be present in an amount ranging from 1,000 kg/h to 20,000 kg/h, including exemplary values of 1,500 kg/h, 2,000 kg/h, 3,000 kg/h, 4,000 kg/h, 5,000 kg/h, 6,000 kg/h, 7,000 kg/h, 8,000 kg/h, 9,000 kg/h, 10,000 kg/h, 11,000 kg/h, 12,000 kg/h, 13,000 kg/h, 14,000 kg/h, 15,000 kg/h, 16,000 kg/h, 17,000 kg/h, 18,000 kg/h, 19,000 kg/h, 19,500 kg/h. In further aspects, the feed can be in a range derived from any two of the above listed exemplary values. For example, the gypsum feed in the drum granulator can be present in an amount ranging from 1,500 kg/h to 19,500 kg/h.

g. Optional Ingredients

In one aspect, the fertilizer composition can comprise magnesium. In one aspect, the magnesium in the fertilizer composition can be magnesium oxide. In another aspect, the fertilizer composition can comprise magnesium oxide, magnesium sulfate, or magnesium nitrate, or a combination thereof.

In another aspect, the fertilizer composition can comprise magnesium in an amount ranging from 0.1 wt % to 2.0 wt %, based on the total weight of the fertilizer composition, including exemplary values of 0.15 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, and 1.95 wt %. In further aspects, the weight percentage can be in a range derived from any two of the above listed exemplary values. For example, the fertilizer composition can comprise magnesium in an amount ranging from 0.15 wt % to 1.95 wt %.

In another aspect, the fertilizer composition comprises a trace element comprising iron, zinc, copper, or manganese, or a combination thereof. In a further aspect, the trace element is chelated or sulfated or both.

In one aspect, the fertilizer composition comprises a trace element in an amount ranging from 1 wt % to 15 wt % based on the total fertilizer composition, including exemplary values of 2 wt %, 3 wt %, 4 wt %, 5 wt %, 6 wt %, 7 wt %, 8 wt %, 9 wt %, 10 wt %, 11 wt %, 12 wt %, 13 wt %, and 14 wt %. In further aspects, the weight percentage can be in a range derived from any two of the above listed exemplary values. For example, the trace element can range from 2 wt % to 14 wt %.

In one aspect, the amount of trace element can be chosen based on the customer's requirements. Further, the amount of trace element can be chosen based on the crop chosen.

In one aspect, the composition comprises a micronutrient. In a further aspect, the micronutrient comprises a trace element. In an even further aspect, the composition comprises a trace element. The trace element can comprise iron, copper, zinc, or manganese, or a combination thereof. In a further aspect, the trace elements can be present in the following ratio of 3:2:1:1 for Iron:Zinc:Magnesium:Copper.

In a further aspect, the micronutrient can provide the composition with a balanced, immediate supply of nutrients to the plants. This balanced, immediate supply can be available to the plant at all growth stages.

In one aspect, the micronutrient source can be EDHA or EDTA based Iron:Zinc:Magnesium:Copper. In a further aspect, the micronutrient source is not a sulfate based product.

In another aspect, the fertilizer composition comprises a micronutrient in an amount ranging from 0.1 wt % to 10 wt %, including exemplary values of 0.15 wt %, 0.2 wt %, 0.3 wt %, 0.4 wt %, 0.5 wt %, 0.8 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 1.95 wt %, 2 wt %, 2.2 wt %, 2.4 wt %, 2.6 wt %,2.8 wt %,3 wt %, 4 wt %, 5 wt %, 6 wt %, 7 wt %, 8 wt %,and 9 wt %. %. In further aspects, the weight percentage can be in a range derived from any two of the above listed exemplary values. For example, the fertilizer composition comprises a micronutrient in an amount ranging from 0.15 wt % to 1.95 wt %.

In another aspect, the composition comprises an anti-caking oil. The anti-caking oil can enable the composition to be a free-flowing composition. The anti-caking oil can also enable the prevention of forming agglomerates in the composition. In one aspect, the anti-caking oil comprises an amine based oil or any other suitable oil.

1. Properties of the Compositions

Generally, the disclosed fertilizer composition of the present invention releases macronutrients nitrogen (N), phosphorus (P), sulfur (S), and potassium (K) and, optionally, micronutrients iron, copper, manganese and zinc into soil in forms that are readily available to the plants through extraction. Fertilizer compositions can be used in any form applied to soil around the intended plants. After application, these types of fertilizer compositions can be watered. When using fertilizer compositions of the present invention, considerations such as soil moisture content, water runoff, soil pH, and plant nutrient needs should be considered. For example, fertilizer compositions comprising monoammonium phosphates (MAP) create a more acidic zone (lower pH) around each granule, and compositions comprising diammonium phosphates (DAP) create a more basic (higher pH) zone. Thus, and without being limited by theory, in high pH soils, MAP-based fertilizers might be better than DAP-based fertilizers because the acid-producing MAP fertilizer would offset the calcareous (i.e., having a high concentration of calcium, Ca²⁻ ion) soils. A concern regarding MAP or DAP selection, aside from soil pH, is potential ammonia toxicity to germinating seeds in dry soils.

In another aspect, a fertilizer composition can comprise a soluble nitrogen (N) source, a soluble phosphorus (P) source, and a soluble potassium (K) source. As such, the composition can be soluble, making it bioavailable for the plant. In a further aspect, the fertilizer composition can comprise sulfate and nitrate nitrogen. The sulfate and nitrate nitrogen can induce acidity in the soil and/or can increase the plant utilization of phosphorus pentoxide. Further, the sulfate can reduce the loss of sulfur in calcalious soils. In another aspect, the availability of sulfur and phosphorus pentoxide can improve the nitrogen uptake by the plants.

In one aspect, the NPK grades of fertilizer having desirable product quality, shape, hardness, non-caking, and high critical relative humidity (CRH) values.

In one aspect, the fertilizer composition can exhibit good crushing strength. As such, the composition can be easier to process.

In one aspect, the fertilizer composition is manufactured as a compound granular fertilizer. The granular fertilizer can be spherical, hard granules. These granules can exhibit superior storage and handling properties, which can be desirable to the merchant and end-user. In one aspect, the compound granular fertilizer is superior to blended fertilizers because every granule in the compound granular fertilizer comprises all the nutrients in the composition.

In a further aspect, the fertilizer composition can be coated with an anti-caking oil. As such, the fertilizer composition can exhibit anti-caking behavior. The anti-caking behavior may be exhibited by the fertilizer composition being free flowing or by substantially no aggregation.

In one aspect, the fertilizer composition has an abrasion resistance ranging from 0.05 wt % degradation to 3.0 wt % degradation, including exemplary values of 0.1 wt % degradation, 0.2 wt % degradation, 0.3 wt % degradation, 0.4 wt % degradation, 0.5 wt % degradation, 0.6 wt % degradation, 0.7 wt % degradation, 0.8 wt % degradation, 0.9 wt % degradation, 1 wt % degradation, 1.1 wt % degradation, 1.2 wt % degradation, 1.3 wt % degradation, 1.4% degradation, 1.5 wt % degradation, 1.6 wt % degradation, 1.7 wt % degradation, 1.8 wt % degradation, 1.9 wt % degradation, 2 wt % degradation, 2.1 wt % degradation, 2.2 wt % degradation, 2.3 wt % degradation, 2.4 wt % degradation, 2.5 wt % degradation, and 2.7 wt % degradation. In further aspects, the abrasion resistance can be in a range derived from any two of the above listed exemplary values. For example, the fertilizer composition has an abrasion resistance ranging from 0.1 wt % degradation to 2 wt % degradation.

In another aspect, the fertilizer composition has a crushing strength ranging from 0.3 kg/granule to 5 kg/granule, including exemplary values of 0.4 kg/granule, 0.5 kg/granule, 0.7 kg/granule, 0.9 kg/granule, 1 kg/granule, 1.1 kg/granule, 1.3 kg/granule, 1.5 kg/granule, 1.7 kg/granule, 1.9 kg/granule, 2 kg/granule, 2.2 kg/granule, 2.4 kg/granule, 2.6 kg/granule, 2.8 kg/granule, 3 kg/granule, 3.2 kg/granule, 3.4 kg/granule, 3.6 kg/granule, 3.8 kg/granule, 4 kg/granule, 4.2 kg/granule, 4.4 kg/granule, 4.6 kg/granule, and 4.8 kg/granule. In further aspects, the crushing strength can be in a range derived from any two of the above listed exemplary values. For example, the fertilizer composition has a crushing strength ranging from 0.4 kg/granule to 4.8 kg/granule.

In a further aspect, the fertilizer composition has a bulk density ranging from 890 kg/m³ to 1060 kg/m³, including exemplary values of 900 kg/m³, 910 kg/m³, 920 kg/m³, 930 kg/m³, 940 kg/m³, 950 kg/m³, 960 kg/m³, 970 kg/m³, 980 kg/m³, 990 kg/m³, 1000 kg/m³, 1010 kg/m³, 1020 kg/m³, 1030 kg/m³, 1040 kg/m³, and 1050 kg/m³. In a further aspect, the bulk density can be in a range derived from any two of the above listed exemplary values. For example, the fertilizer composition has a bulk density ranging from 890 kg/m³ to 1050 kg/m³.

In one aspect, the fertilizer composition has a critical relative humidity at 30° C. ranging from 55% to 80%, including exemplary values of 60%, 65%, 70%, and 75%. In a further aspect, the critical relative humidity can be in a range derived from any two of the above listed exemplary values. For example, the critical relative humidity can range from 65% to 75%.

In one aspect, the fertilizer composition has a moisture absorption ranging from 50 mg/cm² to 240 mg/cm², including exemplary values 60 mg/cm², 70 mg/cm², 80 mg/cm², 90 mg/cm², 100 mg/cm², 110 mg/cm², 120 mg/cm², 130 mg/cm², 140 mg/cm², 150 mg/cm², 160 mg/cm², 170 mg/cm², 180 mg/cm², 190 mg/cm², 200 mg/cm², 210 mg/cm², 220 mg/cm², and 230 mg/cm². In a further aspect, the moisture absorption can be in a range derived from any two of the above listed exemplary values. For example, the moisture absorption can range from 60 mg/cm² to 230 mg/cm².

In another aspect, the fertilizer composition has a moisture penetration ranging from 1.5 cm to 4.0 cm, including exemplary values of 2.0 cm, 2.5 cm, 3.0 cm, and 3.5 cm. In a further aspect, the moisture penetration can be in a range derived from any two of the above listed exemplary values. For example, the moisture penetration can range from 2.0 cm to 3.5 cm.

In a further aspect, the fertilizer composition has a moisture holding capacity ranging from 20 mg/cm² to 70 mg/cm², including exemplary values of 25 mg/cm², 30 mg/cm², 35 mg/cm², 40 mg/cm², 45 mg/cm², 50 mg/cm², 55 mg/cm², 60 mg/cm², and 65 mg/cm². In a further aspect, the moisture holding capacity can be in a range derived from any two of the above listed exemplary values. For example, the moisture holding capacity can range from 30 mg/cm² to 65 mg/cm².

In an even further aspect, the fertilizer composition has a moisture holding capacity ranging from 2.3 wt % to 6.5 wt %, including exemplary values of 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4 wt %, 4.1 wt %, 4.2 wt %, 4.3 wt %, 4.4 wt %, 4.5 wt %, 4.6 wt %, 4.7 wt %, 4.8 wt %, 4.9 wt %, 5 wt %, 5.1 wt %, 5.2 wt %, 5.3 wt %, 5.4 wt %, 5.5 wt %, 5.6 wt %, 5.7 wt %, 5.8 wt %, 5.9 wt %, 6 wt %, 6.1 wt %, 6.2 wt %, 6.3 wt %, and 6.4 wt %. In a further aspect, the moisture holding capacity can be in range derived from any two of the above listed exemplary values. For example, the moisture holding capacity can range from 2.5 wt % to 6 wt %.

In a yet further aspect, the fertilizer composition has a granule integrity of wetted area ranging from fair to good.

In another aspect, the fertilizer composition has a flowability of 100% free flowing after 150 minutes at 30° C. and 90% relative humidity. In a further aspect, the fertilizer composition is 25% nonflowable at 30° C. and 90% relative humidity after 60 min to 150 minutes, including exemplary values of 65 min, 70 min, 75 min, 80 min, 85 min, 90 min, 95 min, 100 min, 105 min, 110 min, 115 min, 120 min, 125 min, 130 min, 135 min, 140 min, and 145 min. In a further aspect, the time can be in a range derived from any two of the above listed exemplary values. For example, the fertilizer composition is 25% nonflowable at 30° C. and 90% relative humidity after 65 min to 140 min.

In another aspect, the fertilizer composition is 50% nonflowable at 30° C. and 90% relative humidity after 110 min to 170 min, including exemplary values of 115 min, 120 min, 125 min, 130 min, 135 min, 140 min, 145 min, 150 min, 155 min, 160 min, and 165 min. In a further aspect, the time can be in a range derived from any two of the above listed exemplary values. For example, the fertilizer composition is 50% nonflowable at 30° C. and 90% relative humidity after 115 min to 165 min.

In a further aspect, the fertilizer composition is 75% nonflowable at 30° C. and 90% relative humidity after 125 min to 180 min, including exemplary values of 130 min, 135 min, 140 min, 145 min, 150 min, 155 min, 160 min, 165 min, 170 min, and 175 min. In a further aspect, the time can be in a range derived from any two of the above listed exemplary values. For example, the fertilizer composition is 75% nonflowable at 30° C. and 90% relative humidity after 130 min to 175 min.

### C. Utility of the Fertilizer Composition

Fertilizer compositions of the present invention add fresh supplies of nitrogen, phosphorus, and potassium, as well as, optionally, micronutrients iron, copper, manganese and zinc to soil where these naturally occurring nutrients have been depleted. In areas where plants have been growing for a long time or are planted repeatedly, such as lawns, flowerbeds, and vegetable plots, the plants use up the primary nutrients over time. Plants that are expected to produce flowers or fruits continuously over an entire season use up soil nutrients faster than even the most fertile soil can provide. The utility of these fertilizer compositions is their mineral macronutrient and micronutrient content, which makes them suitable for plant mineral nutrition and their lack of chloride ions, which makes them more environmentally suitable. Additionally, the fertilizer compositions' content granule size distribution; resistance to abrasion; crushing strength; bulk density; critical relative humidity; moisture absorption and penetration; and flowability profiles make them consistent and predictable sources of plant mineral nutrition as well as material that is handleable, storable, and spreadable with a minimal and acceptable release of dust. Additionally still, the method for preparing fertilizer compositions of the present invention uses a wholly surprising combination of process variables and molar ratios of crystalline and in situ-generated ammonium sulfate that solves granulation problems by, in part, substantially driving off water through heats of reaction that are greater than those provided by crystalline ammonium sulfate alone.

### D. Methods of Making the Compositions

Disclosed herein is a method for producing a fertilizer composition comprising in-situ ammonium sulfate comprising:
a) supplying a mixture of sulfuric acid and phosphoric acid; and
b) adding ammonia and phosphate rock to the mixture, thereby forming single superphosphate or triple superphosphate or a combination thereof and ammonium sulfate.

Also disclosed herein is a method for producing a fertilizer composition comprising ammonium sulfate comprising:
a) supplying a mixture of sulfuric acid and phosphoric acid; and
b) adding ammonia to the mixture, thereby forming mono-ammonium phosphate (MAP) and in-situ ammonium sulfate.

Also disclosed herein is a method for preparing a fertilizer composition comprising:
a) providing a fertilizer comprising a nitrogen compound, a phosphorus compound, a sulfur compound, and one or more potassium compounds, wherein one of the one or more potassium compounds is potassium nitrate; and
b) adding a filler to the fertilizer, wherein the filler comprises gypsum, to form the fertilizer composition.

In another aspect, the method comprises granulating any of the fertilizer compositions. In a further aspect, the method comprises granulating any of the fertilizer compositions after step b in any of the methods.

In one aspect, the in-situ ammonium sulfate is from 80 wt % to 100 wt % of the ammonium sulfate in the fertilizer composition. The ammonium sulfate in the fertilizer composition can also comprise non in-situ ammonium sulfate, which can be added at any time prior to the granualation of the fertilizer composition. For example, the non in-situ ammonium sulfate can be added with the sulfuric acid and phosphoric acid or with the ammonia in the methods. Thus, the non in-situ ammonium sulfate is added in the methods but not produced by the method. The non in-situ ammonium sulfate can be from 0 wt % to 20 wt % of the ammonium sulfate in the fertilizer composition. The non in-situ ammonium sulfate is typically in a solid form.

In one aspect, the formation of the in-situ ammonium sulfate generates an amount of heat operable to produce a set of conditions in a granulator to produce a granule with a diameter ranging from 2 mm to 4.5 mm in size. The heat generated by the reaction of the ammonia and sulfuric acid/phosphoric acid produces a set of conditions in the granulator that allows the granulator/granulating conditions to produce a granule with a diameter ranging from 2 mm to 4.5 mm in size. The reaction between ammonia and sulfuric acid/phosphoric acid also produces water and steam, which can be a part of the set of conditions in the granulator that allows the granulator/granulating conditions to produce a granule with a diameter ranging from 2 mm to 4.5 mm in size. The amount of in-situ ammonium produced by the method determines whether or not the set of conditions in a granulator is present to produce a granule with a diameter ranging from 2 mm to 4.5 mm in size. Accordingly, the method can further comprise granulating the fertilizer into a granule with a diameter ranging from 2 mm to 4.5 mm in size.

Fertilizer compositions of the present invention can be prepared by employing methods as shown herein below, in addition to other standard manipulations that are known in the literature, exemplified in the experimental sections or clear to one skilled in the art.

In one aspect the ammonium sulfate is formed in a pipe reactor. In another aspect, the ammonium sulfate is formed in a pre-neutralizer. A pre-neutralizer is a Continuous Stirred Tank Reactor that usually has a capacity of 20-30 m³. A distribution system inside the reactor allows materials/reactants, for example acid and ammonia, to be introduced and intimately mixed/reacted. The pre-neutralizer also has an extraction system connected to a scrubber system, which allows the steam generated by the process, for example steam produced in an acid/ammonia reaction, to be drawn off and cleaned. The resulting salt liquor, for example ammonium sulfate, is then pumped to a granulator where it is sprayed into the rolling bed to progress the granulation.

In one aspect, the method comprises producing a slurry. In another aspect, the slurry is a liquid with high levels of solid crystals suspended within the liquid. The slurry can then be sprayed within the granulator onto the rolling bed of recycled product. In a further aspect, the sprayed slurry can provide the liquid phase for the granulation.

In one aspect, the mono-ammonium phosphate (MAP) is formed from the reaction of phosphoric acid and ammonia. In another aspect, the MAP can be formed in a pipe reactor. In another aspect, the ammonium sulfate is formed from the reaction of sulfuric acid and ammonia. In a further aspect, the MAP and the ammonium sulfate are formed simultaneously. In a yet further aspect, the MAP and the ammonium sulfate form a slurry.

In one aspect, the method does not comprise forming diammonium phosphate (DAP). In another aspect, the method does not comprise adding diammonium phosphate (DAP). In a further aspect, the method does not comprise adding and/or forming substantially any diammonium phosphate (DAP).

In one aspect, the method does not comprise forming a water insoluble phosphorus. In another aspect, the method does not comprise adding a water insoluble phosphorus. In a further aspect, the method does not comprise forming and/or adding substantially any of a water insoluble phosphorus.

Reactions used to make fertilizer compositions of the present invention are prepared by employing reactions as described in the following procedures, in addition to other standard manipulations known in the literature or to one skilled in the art. The following examples are provided so that the present invention might be more fully understood, are illustrative only, and should not be construed as limiting. In one aspect, the disclosed fertilizer compositions comprise the products of the synthetic methods described herein. In a further aspect, the disclosed fertilizer compositions comprise a material produced by a synthetic method described herein. In a still further aspect, the present invention comprises fertilizer compositions comprising an effective amount of the composition of the disclosed methods and an acceptable binder. In a still further aspect, the present invention comprises methods for manufacturing granular fertilizer compositions comprising combining at least one material of any of disclosed composition or at least one product of the disclosed methods with an acceptable binder.

In one aspect, the method further comprises adding a potassium compound, a sulfur compound, or a phosphorus compound, or a combination thereof. The adding can be performed during any suitable stage of the method.

Starting materials used in one aspect of the process of present invention can be crystalline ammonium sulfate (AS) (Lawrence Farmers Co-Op, Lawrenceburg, Tenn.); zinc sulfate, ferric sulfate, manganese sulfate, copper sulfate, 98% sulfuric acid, and crystalline potassium nitrate (Harcros Chemicals, Inc., Muscle Shoals, Ala.); anhydrous ammonia (Tanner Industries, Inc., Lincoln, Ala.); and merchant-grade phosphoric acid (J.R. Simplot, Pocatello, Id.).

a. Nitrogen

In one aspect, the fertilizer composition can comprise a nitrogen compound. In one aspect, the fertilizer composition can comprise ammoniacal nitrogen or nitrate nitrogen, or a combination thereof. In another aspect, the fertilizer composition can comprise anhydrous ammonia.

In one aspect, the ammoniacal nitrogen can be added to the fertilizer composition in the form of ammonium sulfate. Ammonium sulfate can introduce both nitrogen and sulfur into the soil, which can benefit plant growth. In a further aspect, the ammonium sulfate can be about 100 wt % solid ammonium sulfate formed from a reaction between ammonia and sulfuric acid. In one aspect, the nitrogen content can overlap with the other disclosed contents. For example, ammonium sulfate has both nitrogen content and sulfate content.

In one aspect, the method does not comprise adding an urea-based nitrogen.

In one aspect, the method comprises forming ammonium sulfate from ammonia and sulfuric acid. In another aspect, the ammonia and sulfuric acid in the pipe reactor has a residence time ranging from 1-2 seconds. In another aspect, ammonia and sulfuric acid in the pre-neutralizer has a residence time of about 30 minutes. In a further aspect, the flow rate can depend on the grade of fertilizer manufactured.

In one aspect, the ammonium sulfate comprises in-situ ammonium sulfate. In another aspect, the ammonium sulfate comprises in-situ ammonium sulfate and crystalline ammonium sulfate. As used herein, in-situ ammonium sulfate refers to the ammonium sulfate formed in a reactor and pre-neutralized by reacting ammonia with sulfuric acid. Such in-situ ammonium sulfate can be used directly as an ingredient in the fertilizer composition.

In one aspect, the ammonium sulfate comprises in-situ ammonium sulfate in an amount ranging from 80 wt % to 100 wt % of the total ammonium sulfate, including exemplary values of 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, and 99 wt %. In further aspects, the weight percentage can be in a range derived from any two of the above listed exemplary values. For example, the ammonium sulfate can comprise in-situ ammonium sulfate in an amount ranging from 81 wt % to 95 wt %. In another example, the ammonium sulfate can comprise in-situ ammonium sulfate in an amount ranging from 85 wt % to 100 wt %. In yet another example, the ammonium sulfate can comprise in-situ ammonium sulfate in an amount ranging from 90 wt % to 100 wt %. In yet another example, the ammonium sulfate can comprise in-situ ammonium sulfate in an amount ranging from 95 wt % to 100 wt %. In another example, the ammonium sulfate can comprise in-situ ammonium sulfate in an amount ranging from 98 wt % to 100 wt %.

In another aspect, the ammonium sulfate comprises non in-situ ammonium sulfate in an amount ranging from 0 wt % to 20 wt % of the total ammonium sulfate, including exemplary values of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, and 19 wt %. In further aspects, the weight percentage can be in a range derived from any two of the above listed exemplary values. For example, the ammonium sulfate can comprise non in-situ ammonium sulfate in an amount ranging from 1 wt % to 19 wt %. In another example, the ammonium sulfate can comprise non in-situ ammonium sulfate in an amount ranging from 0 wt % to 15 wt %. In yet another example, the ammonium sulfate can comprise non in-situ ammonium sulfate in an amount ranging from 0 wt % to 10 wt %. In yet another example, the ammonium sulfate can comprise non in-situ ammonium sulfate in an amount ranging from 0 wt % to 5 wt %. In yet another example, the ammonium sulfate can comprise non in-situ ammonium sulfate in an amount ranging from 0 wt % to 2 wt %.

In one aspect, the ammonia is added as liquid ammonia. In a further aspect, the ammonia is added at around 5° C. In an even further aspect, the sulfuric acid can be added to the solution from the scrubbing system and is added at ambient temperature or at around 35° C.

In one aspect, the total nitrogen content in the fertilizer composition ranges from 5 wt % to 30 wt %, including exemplary values 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %,24 wt %,25 wt %, 26 wt %, 27 wt %, 28 wt %,and29 wt %. In further aspects, the weight percentage can be in a range derived from any two of the above listed exemplary values. For example, the total nitrogen content can range from 12 wt % to 20 wt %.

In another aspect, the nitrogen content in the fertilizer composition ranges from 10 wt % to 20 wt %, including exemplary values 11 wt %, 12 wt %, 13 wt %, 14 wt %, 15 wt %, 16 wt %, 17 wt %, 18 wt %, and 19 wt %. In further aspects, the weight percentage can be in a range derived from any two of the above listed exemplary values. For example, the nitrogen content in the fertilizer composition can range from 11 wt % to 19 wt %.

In one aspect, the fertilizer composition comprises ammoniacal nitrogen in an amount ranging from 3 wt % to 25 wt %, including exemplary values of 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, and 24 wt %. In further aspects, the weight percentage can be in a range derived from any two of the above listed exemplary values. For example, the nitrogen content can comprise ammoniacal nitrogen in an amount ranging from 6 wt % to 17 wt %.

In another aspect, the nitrogen content comprises nitrate nitrogen in an amount ranging from 0.5 wt % to 9 wt %, including exemplary values of 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, and 8.0 wt %. In further aspects, the weight percentage can be in a range derived from any two of the above listed exemplary values. For example, the fertilizer composition can comprise nitrate nitrogen in an amount ranging from 1.0 wt % to 8.0 wt %.

In one aspect, the nitrogen feed in the pipe-cross reactor can be present in an amount ranging from 500 kg/h to 410,000 kg/h, including exemplary values of 600 kg/h, 800 kg/h, 1000 kg/h, 1300 kg/h, 1500 kg/h, 2000 kg/h, 3000 kg/h, 4000 kg/h, 5000 kg/h, 6000 kg/h, 7000 kg/h, 8000 kg/h, 9000 kg/h, 10,000 kg/h, 20,000 kg/h, 30,000 kg/h, 40,000 kg/h, 50,000 kg/h, 60,000 kg/h, 80,000 kg/h, 100,000 kg/h, 150,000 kg/h, 200,000 kg/h, 250,000 kg/h, 300,000 kg/h, 350,000 kg/h, 400,000 kg/h. In further aspects, the feed can be in a range derived from any two of the above listed exemplary values. For example, the nitrogen feed can range from 500 kg/h to 8000 kg/h. In one aspect, the nitrogen in the nitrogen feed can comprise ammonia.

In another aspect, the nitrogen feed in the drum granulator can be present in an amount ranging from 100 kg/h to 3,000 kg/h, including exemplary values of 200 kg/h, 300 kg/h, 500 kg/h, 800 kg/h, 1100 kg/h, 1500 kg/h, 1800 kg/h, 2100 kg/h, 2400 kg/h, and 2700 kg/h. In further aspects, the feed can be in a range derived from any two of the above listed exemplary values. For example, the nitrogen feed in the drum granulator can be present in an amount ranging from 800 kg/h to 2,500 kg/h.

In a further aspect, using a high ratio of crystalline ammonium sulfate to in situ ammonium sulfate production allows for improved granulation process control and improved granular crushing strength. In one aspect, the ratio of crystalline ammonium sulfate to in situ ammonium sulfate can be in a range of 50 wt % to 100 wt %, including exemplary values of 55 wt %, 60 wt %, 65 wt %, 70 wt %, 75 wt %, 80 wt %, 85 wt %, 90 wt %, and 95 wt %. In further aspects, the ratio can be in a range derived from any two of the above listed exemplary values. For example, the ratio of crystalline ammonium sulfate to in situ ammonium sulfate can be in a range of 30 wt % to 70 wt %.

In one aspect, using low recycle ratio in the range of 1 to 4 can allow for better control on the granulation and final product crushing strength. Here, the low recycling ratio can be for the granulation seed material versus fresh feeds to the granulator.

For 12-12-17 Grades, nitrogen content comprised about 7.0 wt % to about 7.5 wt % ammoniacal nitrogen and about 4.9 wt % to about 5.2 wt % nitrate nitrogen; for 15-15-15 Grades, nitrogen content comprised about 9.7 wt % to about 10.2 wt % ammoniacal nitrogen and about 4.4 wt % to about 4.9 wt % nitrate nitrogen; for 16-16-16 Grades, nitrogen content comprised about 10.0 wt % to about 10.4 wt % ammoniacal nitrogen and about 4.8 wt %-5.3 wt % nitrate nitrogen; and for 18-18-5 Grades, nitrogen content comprised about 15.6 wt % to about 16.1 wt % ammoniacal nitrogen and about 1.6 wt % to about 2.1 wt % nitrate nitrogen.

b. Phosphorus

In one aspect, the fertilizer composition can comprise a phosphorus compound. Phosphorus content in the fertilizer compositions can comprise water-soluble or citrate-soluble phosphorus pentoxide, or a combination thereof.

The phosphorus compound can be added to the fertilizer composition in the form of diammonium phosphate (DAP) or monoammonium phosphate (MAP) or a combination thereof. The DAP or the MAP can be made directly at the manufacturing site from ammonia and phosphoric acid. In one aspect, the phosphoric acid can be merchant grade. In another aspect, the DAP or the MAP can provide high levels of water-soluble phosphorus pentoxide. The DAP or the MAP or a combination thereof can allow the phosphorus content to be available to the plant, which can benefit plant growth. In one aspect, the phosphorus content can overlap with the other disclosed contents.

In one aspect, the phosphorus compound can be added to the fertilizer composition in the form of single superphosphate (SSP) or triple superphosphate (TSP) or a combination thereof. In another aspect, the SSP or TSP can be added as a dry feed. In a further aspect, the addition of the SSP or TSP could alter the solid: liquid ratio in the granulation step. As such, the solid: liquid ratio can require adjustment to allow for the formation of granules.

In one aspect, the SSP can comprise a phosphate content of 18 wt %. In a further aspect, the TSP can comprise a phosphate content of 48 wt %.

In another aspect, SSP can be used as a substitute for some NPK grades with low phosphate requirements. In a further aspect, the amount of substitution by SSP or TSP or a combination thereof that is possible can depend on the NPK grade required.

In one aspect, the total phosphorus pentoxide in the fertilizer composition ranges from 5 wt % to 30 wt %, including exemplary values 6 wt %, 7 wt %, 8 wt %, 9 wt %, 10 wt %, 11 wt %,12 wt %,13 wt %, 14 wt %, 15 wt %,16 wt %, 17 wt %,18 wt %,19 wt %, 20 wt %,21 wt %, 22 wt %,23 wt %,24 wt %, 25 wt %,26wt %,27 wt %, 28 wt %,and 29 wt %. In further aspects, the weight percentage can be in a range derived from any two of the above listed exemplary values. For example, the total phosphorus pentoxide in the fertilizer composition can range from 12 wt % to 20 wt %.

In one aspect, the phosphorus pentoxide in the fertilizer composition ranges from 10 wt % to 20 wt %, including exemplary values 11 wt %, 12 wt %, 13 wt %, 14 wt %, 15 wt %, 16 wt %, 17 wt %, 18 wt %, and 19 wt %. In further aspects, the weight percentage can be in a range derived from any two of the above listed exemplary values. For example, the phosphorus pentoxide in the fertilizer composition can range from 11 wt % to 19 wt %.

In another aspect, the fertilizer composition comprises water-soluble phosphorus pentoxide in an amount ranging from 5 wt % to 20 wt %, including exemplary values 7 wt %, 8 wt %, 9 wt %, 10 wt %, 11 wt %, 12 wt %, 13 wt %, 14 wt %, 15 wt %, 16 wt %, 17 wt %, 18 wt %, and 19 wt %. In further aspects, the weight percentage can be in a range derived from any two of the above listed exemplary values. For example, the fertilizer composition can comprise water-soluble phosphorus pentoxide in an amount ranging from 8 wt % to 17 wt %.

In a further aspect, the fertilizer composition comprises citrate soluble phosphorus pentoxide in an amount ranging from 0.5 wt % to 5 wt %, including exemplary values 1 wt %, 1.1 wt %, 1.2 wt %, 1.4 wt %, 1.5 wt %, 1.7 wt %, 2 wt %, 2.2 wt %, 2.3 wt %, 2.5 wt %, 2.7 wt %, 2.9 wt %, 3 wt %, 3.2 wt %, 3.4 wt %, 3.6 wt %, 3.8 wt %, 3.9 wt %, 4 wt %, 4.2 wt %, 4.5 wt %, and 4.7 wt %. In further aspects, the weight percentage can be in a range derived from any two of the above listed exemplary values. For example, the fertilizer composition can comprise citrate soluble phosphorus pentoxide in an amount ranging from 1.1 wt % to 3.9 wt %.

In one aspect, the phosphorus feed in the pipe-cross reactor can be present in an amount ranging from 1,000 kg/h to 15,000 kg/h, including exemplary values of 2,000 kg/h, 3,000 kg/h, 4,000 kg/h, 5,000 kg/h, 6,000 kg/h, 7,000 kg/h, 8,000 kg/h, 9,000 kg/h, 10,000 kg/h, 11,000 kg/h, 12,000 kg/h, 13,000 kg/h, and 14,000 kg/h. In further aspects, the feed can be present in a range derived from any two of the above listed exemplary values. For example, the phosphorus feed in the pipe-cross reactor can be present in an amount 1,500 kg/h to 14,500 kg/h. In one aspect, the phosphorus feed can comprise phosphoric acid, a MAP solution, a DAP solution, or a combination thereof.

For 12-12-17 Grades, phosphorus content comprised about 8.6 wt % to about 10.5 wt % water-soluble phosphorus and about 1.1 wt % to about 3.9 wt % citrate-soluble phosphorus; for 15-15-15 Grades, phosphorus content comprised about 11.4 wt % to about 13.1 wt % water-soluble phosphorus and about 1.2 wt % to about 2.5 wt % citrate-soluble phosphorus; for 16-16-16 Grades, phosphorus content comprised about 12.7 wt % to about 14.6 wt % water-soluble phosphorus and about 1.9% citrate soluble phosphorus; and for 18-18-5 Grades, phosphorus content comprised about 15.8 wt % to about 16.6 wt % water-soluble phosphorus and about 2.0 wt % to about 2.3 wt % citrate-soluble phosphorus.

c. Sulfur

In one aspect, the fertilizer composition can comprise a sulfur compound. In one aspect, the amount of sulfur compound of the fertilizer compositions of the present invention can be expressed as the weight percent sulfate. For example, the fertilizer composition can comprise calcium sulfate or ammonium sulfate, or a combination thereof. In one aspect, the sulfur compound can overlap (be the same compound) as other compound in the fertilizer composition. For example, the sulfur compound can be same as the nitrogen compound.

In one aspect, the sulfur compound in the fertilizer composition can be present as a sulfate. The sulfur can be present in the fertilizer composition in the range of from 5 wt % to 15 wt %, including exemplary values of 5.5 wt %, 6 wt %, 7 wt %, 8 wt %, 9 wt %, 10 wt %, 11 wt %, 12 wt %, 13 wt %, 14 wt %, and 14.5 wt % based on the total weight of the fertilizer composition. In further aspects, the weight percentage can be in a range derived from any two of the above listed exemplary values. For example, the sulfur can be present in the fertilizer composition in the range of from 5.5 wt % to 14.5 wt %.

For 12-12-17 Grades, sulfur content comprises about 6.2 wt % to about 9.0 wt %; for 15-15-15 Grades, sulfur content comprises about 6.9 wt % to about 10.2 wt %; for 16-16-16 Grades, sulfur content comprises about 6.9 wt % to 9.0 wt %; and for 18-18-5 Grades, sulfur content comprises 10.2 wt % to 12.4 wt %.

d. Potassium

In one aspect, the method comprises adding a potassium compound.

In one aspect, the fertilizer composition comprises a potassium compound. In one aspect, the amount of potassium compound in the fertilizer composition can be expressed as the percent potassium oxide. In another aspect, the fertilizer composition can comprise potassium nitrate. In one aspect, the potassium compound in the fertilizer composition does not comprise potassium chloride. In another aspect, the fertilizer composition is substantially free of potassium chloride. In a further aspect, the fertilizer composition does not comprise potassium sulfate. In an even further aspect, the fertilizer composition is substantially free of potassium sulfate.

Some localities prohibit or restrict the amount of chloride ions that can be introduced into the soil. As such, for these localities, the use of potassium nitrate over potassium chloride avoids or restricts the introduction of chloride ions into the soil.

In one aspect, the fertilizer composition comprises potassium nitrate and the fertilizer composition is a granular fertilizer.

In one aspect, the fertilizer composition comprises potassium nitrate. The potassium nitrate can provide a high level of nitrogen to the plants to enhance plant growth. In a further aspect, the potassium content is highly soluble. In an even further aspect, the potassium content of the invention has a higher soluble than the solubility of a similar composition using potassium sulfate. In a yet further aspect, the potassium nitrate is more soluble than potassium sulfate, making the inventive composition more soluble than a comparative composition with potassium sulfate. The enhanced solubility can make the potassium nutrient more available to the plant, which can enhance plant growth.

In one aspect, the total potassium in the fertilizer composition ranges from 1 wt % to 30 wt %, including exemplary values 1.5 wt %, 2 wt %, 4 wt %, 6 wt %, 7 wt %, 8 wt %, 9 wt %,10 wt %, 11 wt %,12wt %,13 wt %, 14 wt %,15 wt %, 16 wt %,17 wt %,18 wt %, 19 wt %, 19.5 wt %, 20 wt %, 21 wt %, 22 wt %, 23 wt %, 24 wt %, 25 wt %, 26 wt %,27 wt %, 28 wt %, and 29 wt %. In further aspects, the weight percentage can be in a range derived from any two of the above listed exemplary values. For example, the total potassium in the fertilizer composition can range from 1.5 wt % to 19.5 wt %.

In another aspect, the fertilizer composition comprises potassium oxide in an amount ranging from 1 wt % to 25 wt %, including exemplary values 1.5 wt %, 2 wt %, 4 wt %, 5 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, and 24.5 wt %. In further aspects, the weight percentage can be in a range derived from any two of the above listed exemplary values. For example, the fertilizer composition can comprise potassium oxide in an amount ranging from 1.5 wt % to 24.5 wt %.

In another aspect, the fertilizer composition comprises potassium oxide in an amount ranging from 5 wt % to 18 wt %, including exemplary values 6 wt %, 7 wt %, 8 wt %, 9 wt %, 10 wt %, 11 wt %, 12 wt %, 13 wt %, 14 wt %, 15 wt %, 16 wt %, and 17 wt %. In further aspects, the weight percentage can be in a range derived from any two of the above listed exemplary values. For example, the fertilizer composition can comprise potassium oxide in an amount ranging from 6 wt % to 17 wt %.

In another aspect, the potassium feed in the drum granulator can be present in an amount ranging from 1,000 kg/h to 20,000 kg/h, including exemplary values of 1,500 kg/h, 2,000 kg/h, 3,000 kg/h, 4,000 kg/h, 5,000 kg/h, 6,000 kg/h, 7,000 kg/h, 8,000 kg/h, 9,000 kg/h, 10,000 kg/h, 11,000 kg/h, 12,000 kg/h, 13,000 kg/h, 14,000 kg/h, 15,000 kg/h, 16,000 kg/h, 17,000 kg/h, 18,000 kg/h, 19,000 kg/h, 19,500 kg/h. In further aspects, the feed can be in a range derived from any two of the above listed exemplary values. For example, the potassium feed in the drum granulator can be present in an amount ranging from 1,500 kg/h to 19,500 kg/h. In one aspect, the potassium feed comprises potassium nitrate.

For 12-12-17 Grades, potassium oxide content comprised about 16.0 wt % to about 18.0 wt %; for 15-15-15 Grades, potassium oxide content comprised about 14.0 wt % to about 16.0 wt %; for 16-16-16 Grades, potassium oxide content comprised about 15.0 wt % to about 17.0 wt %; and for 18-18-5 Grades, potassium content comprised about 4.0 wt % to about 6.0 wt %.

e. Filler

In one aspect, the filler comprises gypsum. In another aspect, the filler comprises single superphosphate or triple superphosphate or a combination thereof. In a further aspect, the filler does not comprise gypsum.

In a further aspect, the fertilizer composition does not comprise gypsum.

In one aspect, the filler comprises sand, limestone, dolomite, or clay or a combination thereof. In a further aspect, the filler can comprise more than one filler. In an even further aspect, the filler can be any filler conventionally used in fertilizer compositions.

In one aspect, the method comprises adding a filler. In another aspect, the method does not comprise adding gypsum.

Without being bound by theory, the filler can be used to prevent over-formulation of the NPK grade. Further, the use of a filler can reduce the cost of the fertilizer, for example, by the filler being cheaper than the other ingredients of the fertilizer. In another aspect, the filler can be added as a granulation aid. As such, the filler can promote the granulation performance and can make the control of the granulation process easier. In a further aspect, a filler comprising an inert filler, such as sand, may not have a granulation enhancement affect. In an even further aspect, the filler can comprise a combination of fillers that have a balance between using the cheapest filler while maintaining the granulation process performance.

In one aspect, TSP is formed from the reaction of phosphate rock and phosphoric acid. In another aspect, the ratio between the phosphate rock to phosphoric acid is dependent on the other impurities within the phosphate rock. For example, the impurity could comprise calcium oxide which can vary from source to source or shipment to shipment depending, for example, on the natural variations in the mine In a further aspect, the phosphoric acid to phosphate rock can be in a ratio about 2.5:1.

In one aspect, the SSP or the TSP or a combination thereof can be added in solid form. In another aspect, the solid can be added to the granulation circuit via a weight feeder conveyor. In a further aspect, the SSP or the TSP can be purchased commercially or manufactured directly using phosphoric acid and phosphate rock. In an even further aspect, the SSP or the TSP can enter the granulator as a slurry. In a yet further aspect, the slurry enters the granulator at 120° C.

In one aspect, the SSP or the TSP can be added directly to the process at ambient temperature. The SSP or the TSP can be manufactured directly using phosphoric acid at ambient temperature with liquid ammonia at 5° C.

The calcium and/or sulfur in gypsum can be a source of desirable secondary nutrients for plants. Gypsum is known to one skilled in the art and is commercially available. It is commonly known that gypsum comprises calcium sulfate di-hydrate (CaSO₄.2H₂O). In another aspect, the gypsum can also act as a granulation aid in the manufacturing process. In a further aspect, the gypsum, as a granulation aid, can produce hard, round granules. In a further aspect, the gypsum fill can act as a desalinating material for a saline soil.

In one aspect, the gypsum can be present in the fertilizer composition in an amount ranging from 2 wt % to 30 wt %, based on the total weight of the fertilizer composition, including exemplary values 2.5 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, and 29.5 wt %. In further aspects, the weight percentage can be in a range derived from any two of the above listed exemplary values. For example, the gypsum can be present in the fertilizer composition in an amount ranging from 2.5 wt % to 29.5 wt %.

In a further aspect, the gypsum feed in the drum granulator can be present in an amount ranging from 1,000 kg/h to 20,000 kg/h, including exemplary values of 1,500 kg/h, 2,000 kg/h, 3,000 kg/h, 4,000 kg/h, 5,000 kg/h, 6,000 kg/h, 7,000 kg/h, 8,000 kg/h, 9,000 kg/h, 10,000 kg/h, 11,000 kg/h, 12,000 kg/h, 13,000 kg/h, 14,000 kg/h, 15,000 kg/h, 16,000 kg/h, 17,000 kg/h, 18,000 kg/h, 19,000 kg/h, 19,500 kg/h. In further aspects, the feed can be in a range derived from any two of the above listed exemplary values. For example, the gypsum feed in the drum granulator can be present in an amount ranging from 1,500 kg/h to 19,500 kg/h.

f. Optional Ingredients

In one aspect, the composition can comprise magnesium. The magnesium can be expressed as the percent of magnesium oxide. The magnesium can comprise magnesium oxide, magnesium sulfate, or magnesium nitrate, or a combination thereof.

In another aspect, the composition can comprise magnesium in an amount ranging from 0.1 wt % to 2.0 wt %, based on the total weight of the fertilizer composition, including exemplary values of 0.15 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, and 1.95 wt %. In further aspects, the weight percentage can be in a range derived from any two of the above listed exemplary values. For example, the composition can comprise magnesium in an amount ranging from 0.15 wt % to 1.95 wt %.

In another aspect, the fertilizer composition comprises a trace element comprising iron, zinc, copper, or manganese, or a combination thereof. In a further aspect, the trace element is chelated or sulfated or both.

In one aspect, the fertilizer composition comprises a trace element in an amount ranging from 1 wt % to 15 wt % based on the total fertilizer composition, including exemplary values of 2 wt %, 3 wt %, 4 wt %, 5 wt %, 6 wt %, 7 wt %, 8 wt %, 9 wt %, 10 wt %, 11 wt %, 12 wt %, 13 wt %, and 14 wt %. In further aspects, the weight percentage can be in a range derived from any two of the above listed exemplary values. For example, the trace element can range from 2 wt % to 14 wt %.

In one aspect, the amount of trace element can be chosen based on the customer's requirements. Further, the amount of trace element can be chosen based on the crop chosen.

In one aspect, the composition comprises a micronutrient. In a further aspect, the micronutrient comprises a trace element. In an even further aspect, the composition comprises a trace element. The trace element can comprise iron, copper, zinc, or manganese, or a combination thereof. In a further aspect, the trace elements can be present in the following ratio of 3:2:1:1 for Iron:Zinc:Magnesium:Copper.

In a further aspect, the micronutrient can provide the composition with a balanced, immediate supply of nutrients to the plants. This balanced, immediate supply can be available to the plant at all growth stages.

In one aspect, the micronutrient source can be EDHA or EDTA based Iron:Zinc:Magnesium:Copper. In a further aspect, the micronutrient source is not a sulfate based product.

In another aspect, the composition comprises a micronutrient in an amount ranging from 0.1 wt % to 10 wt %, including exemplary values of 0.15 wt %, 0.2 wt %, 0.3 wt %, 0.4 wt %, 0.5 wt %, 0.8 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 1.95 wt %, 2 wt %, 2.2 wt %, 2.4 wt %, 2.6 wt %, 2.8 wt %, 3 wt %, 4 wt %, 5 wt %, 6 wt %, 7 wt %, 8 wt %, and 9 wt %. %. In further aspects, the weight percentage can be in a range derived from any two of the above listed exemplary values. For example, the composition comprises a micronutrient in an amount ranging from 0.15 wt % to 1.95 wt %.

In another aspect, the composition comprises an anti-caking oil. The anti-caking oil can enable the composition to be a free-flowing composition. The anti-caking oil can also enable the prevention of forming agglomerates in the composition. In one aspect, the anti-caking oil comprises an amine based oil or any other suitable oil.

g. Overview

The processes of the present invention can comprise a melt granulation process or a pipe-cross reactor (PCR) adapted for production of monoammonium phosphate (MAP) and diammonium phosphate (DAP). NPK fertilizer grades of the present invention can be produced using equipment including the PCR, a dryer, a cooler, and classifying screens that separated undersized and oversized particles from the product mixture, such that oversized particles could be crushed and rescreened. Bucket elevators and belt conveyers can transfer raw materials, product, recyclables and dust. Exhaust gasses can contact with an acidified solution in a scrubber. Exhaust air from the dryer and cooler can pass through cyclones to remove larger dust particles and wet scrubbers or bag houses to remove smaller particles.

In one aspect, the composition can be granulated in a conventional drum granulation and a drying process. After drying, in one aspect, the product can be treated conventionally after the drier; screened, cooled, and oil coated before being stored.

In another aspect, the dryer product outlet moisture content is below 0.5 wt %. In an even further aspect, the dryer product outlet moisture content ranges from 0.01 wt % to 0.5 wt %, including exemplary values of 0.05 wt %, 0.1 wt %, 0.15 wt %, 0.2 wt %, 0.25 wt %, 0.3 wt %, 0.35 wt %, 0.4 wt %, and 0.45 wt %. In further aspects, the weight percentage can be in a range derived from any two of the above listed exemplary values. For example, the dryer product outlet moister content ranges from 0.05 wt % to 0.5 wt %.

In a further aspect, the granulation operating temperature in the range of from 60° C. to 100° C., including exemplary values 65° C., 70° C., 75° C., 80° C., 85° C., 90° C., and 95° C. In further aspects, the granulation operating temperature can be in a range derived from any two of the above listed exemplary temperatures. For example, the granulation operating temperature can be in the range of from 70° C. to 90° C.

In another aspect, the ambient conditions during the process has a relative humility in the range of 35% to 99%, including exemplary values 40%, 42%, 43%, 45%, 47%, 49%, 50%, 53%, 55%, 57%, 60%, 63%, 65%, 67%, 69 wt %, 70 wt %, 73 wt %, 75%, 78%, 79%, 80%, 83%, 85%, 87%, 89%, 90%, 93%, 95%, and 97%. In further aspects, the relative humility can be in a range derived from any two of the above listed exemplary values. For example, the relative humility can be in the range of 40% to 87%.

In a further aspect, the ambient conditions during the process has a temperature in the range of 20° C. to 40° C., including exemplary values of 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., and 39° C. In further aspects, the temperature can be in a range derived from any two of the above listed exemplary values. For example, the temperature can be in the range of 27° C. to 35° C.

In a further aspect, the pipe surface temperature at 45.7 cm from the cross in the range of 40° C. to 125° C., including exemplary values of 45° C., 50° C., 55° C., 60° C., 65° C., 70° C., 75° C., 80° C., 85° C., 90° C., 95° C., 100° C., 105° C., 110° C., 115° C. In fur, and 120° C. In further aspects, the temperature can be in a range derived from any two of the above listed exemplary values. For example, the temperature can be in the range of 40° C. to 120° C.

In a further aspect, the pipe surface temperature at 121.9 cm from the cross in the range of 85° C. to 135° C., including exemplary values of 90° C., 95° C., 100° C., 105° C., 110° C., 115° C., 120° C., 125° C., and 130° C. In further aspects, the temperature can be in a range derived from any two of the above listed exemplary values. For example, the temperature can be in the range of 90° C. to 125° C.

In another aspect, the pipe surface temperature at 198.1 cm from the cross in the range of 105° C. to 135° C., including exemplary values of 110° C., 115° C., 120° C., 125° C., and 130° C. In further aspects, the temperature can be in a range derived from any two of the above listed exemplary values. For example, the temperature can be in the range of from 110° C. to 130° C.

In one aspect, the method can have a bed temperature ranging from 60° C. to 90° C., including exemplary values of 65° C., 70° C., 75° C., 80° C., and 85° C. In still further aspects, the bed temperature can be in a range derived from any two of the above listed exemplary bed temperatures. For example, the method can have a bed temperature ranging from 70° C. to 90° C.

In one aspect, the method can have a recycle temperature ranging from 60° C. to 90° C., including exemplary values of 65° C., 70° C., 75° C., 80° C., and 85° C. In still further aspects, the recycle temperature can be in a range derived from any two of the above listed exemplary recycle temperature ranges. For example, the method can have a recycle temperature ranging from 70° C. to 90° C.

In one aspect, the granulator discharge pH ranges from 4 to 8, including exemplary values of 4.1, 4.2, 4.3, 4.4, 4.5, 4.6, 4.7, 4.8, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, and 7.9. In further aspects, the pH can be in a range derived from any two of the above listed exemplary pHs. For example, the pH can range from 4.4 to 7.7.

In another aspect, the fertilizer composition exhibits a pH ranging from 3 to 5, including exemplary values of 3.2, 3.4, 3.6, 3.8, 4, 4.2, 4.4, 4.6, and 4.8. In further aspects, the pH can be in a range derived from any two of the above listed exemplary pHs. For example, the pH can range from 3.2 to 4.8.

In one aspect, the granulation step produces a granule with a diameter ranging from 2 mm to 4.5 mm in size, including exemplary values of 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, and 4.4 mm. For example, the granule can have a diameter ranging from 2.1 mm to 4.4 mm in size.

In another aspect, the granulator discharge NH₃:H₃PO₄ mole ratio can be in a range from 1 to 2, including exemplary values 1.1, 1.2, 1.3, 1.4, 1.5, 1.6, 1.7, 1.8, and 1.9. In further aspects, the mole ratio can be in a range derived from any two of the above listed exemplary values. For example, the mole ratio can be in a range from 1 to 1.9.

In another aspect, the granulator discharge NH₃:H₃PO₄ mole ratio can be either in the mono-ammonium phosphate pH range from 0.8 to 1.2 or in the di-ammonium pH range from 1.6 to 2, including exemplary values 0.85, 0.9, 1.0, 1.1, 1.15, 1.2, 1.65, 1.7, 1.8, 1.9, and 1.85. In further aspects, the mole ratio can be in a range derived from any two of the above listed exemplary values. For example, the mole ratio can be in a range from 0.85 to 1.15 or from 1.65 to 1.95.

In an even further aspect, the rotational speed ranges from 13 rpm to 23 rpm, including exemplary values of 14 rpm, 15 rpm, 16 rpm, 17 rpm, 18 rpm, 19 rpm, 20 rpm, 21 rpm, and 22 rpm. In a further aspect, the rotational speed can be in a range derived from any two of the above listed exemplary values. For example, the rotational speed can range from 16 rpm to 19 rpm.

In yet another aspect, the drum speed ranges from 33% to 45%, as the fraction of critical, including exemplary values of 35%, 36%, 37%, 38%, 39%, 40%, 41%, 42%, 43%, and 44%. In a further aspect, the drum speed can be in a range derived from any two of the above listed exemplary values. For example, the drum speed can range from 36% to 43%.

For the methods of making, any of the inventive compositions or methods of using recited herein throughout this specification can be employed.

### E. Methods of Using the Compositions

Hence, fertilizer compositions of the present invention can be used to provide plant nutrients by replenishment of the nutrients in the soil. Accordingly, methods of using such fertilizer compositions comprise contacting the composition with a plant or with soil. Fertilizer application depends on factors including, but not limited to, fertilizer composition, plant mineral nutritional needs, soil, and type of equipment used. In one aspect, a dry fertilizer can move into the soil by being dissolved in water, are absorbed by roots, and translocated throughout the plant, reaching plant leaves. In one aspect, the way to apply fertilizer compositions: broadcasting, which comprises uniform fertilizer distribution over an entire area and placement, which comprises application of fertilizer in bands or in pockets near the plants or plant rows. Dry fertilizers can be applied using mechanical spreaders, such as broadcast spreaders (e.g., hand-held broadcasters and walk-behind broadcasters) and/or drop spreaders.

In one aspect, the present invention discloses a product made by the methods disclosed herein.

In one aspect, the application temperature ranges from 10° C. to 40° C., including exemplary values of 15° C., 20° C., 25° C., 30° C., and 35° C. In still further aspects, the application temperature can be in a range derived from any two of the above listed exemplary application temperatures. For example, the application temperature can range from 15° C. to 40° C.

In the methods of using, any of the inventive compositions or methods recited herein throughout this specification can be employed.

### F. Aspects

The disclosed methods include at least the following aspects.

Aspect 1: A fertilizer composition comprising:
a) a fertilizer comprising a nitrogen compound, a phosphorus compound, a sulfur compound, and one or more potassium compounds, wherein one of the one or more potassium compounds is potassium oxide, and
b) a filler, wherein the filler comprises single superphosphate or triple superphosphate or a combination thereof.

Aspect 2: A fertilizer composition comprising:
a) a fertilizer comprising one or more nitrogen compounds, one or more phosphorus compounds, a sulfur compound, and one or more potassium compounds, wherein one of the one or more potassium compounds is potassium oxide; wherein one of the one or more nitrogen compounds is ammonium sulfate; and wherein one of the one or more phosphorus compounds is mono-ammonium phosphate (MAP); and
b) a filler.

Aspect 3: The fertilizer composition of aspect 2, wherein the filler comprises single superphosphate or triple superphosphate or a combination thereof.

Aspect 4: The fertilizer composition of aspects 2 or 3, wherein the filler comprises one or more phosphorus compounds.

Aspect 5: The fertilizer composition of aspects 2 or 3, wherein the filler does not comprise one or more phosphorus compounds.

Aspect 6: The fertilizer composition of any one of aspects 2-5, wherein the one or more phosphorus compounds is mono-ammonium phosphate (MAP).

Aspect 7: The fertilizer composition of any one of aspects 2-5, wherein the fertilizer comprises mono-ammonium phosphate (MAP) and another phosphorus compound.

Aspect 8: The fertilizer composition of any one of aspects 1-7, wherein the fertilizer comprises nitrogen in the range of from 10 wt % to 20 wt %; P₂O₅ in the range of from 10 wt % to 20 wt %; K₂O in the range of from 5 wt % to 18 wt %; and sulfate in the range of from 5 wt % to 15 wt %.

Aspect 9: The fertilizer composition of any one of aspects 1-8, wherein the fertilizer composition does not comprise potassium chloride or potassium sulfate.

Aspect 10: The fertilizer composition of any one of aspects 1-9, wherein the fertilizer composition comprises an ammoniacal nitrogen source or a nitrate nitrogen source.

Aspect 11: The fertilizer composition of aspect 10, wherein the fertilizer composition comprises an ammoniacal nitrogen source that comprises monoammonium phosphate-based ammoniacal nitrogen, diammonium phosphate-based ammoniacal nitrogen, or ammonium sulfate-based ammoniacal nitrogen, or a combination thereof.

Aspect 12: The fertilizer composition of any one of aspects 1-11, wherein the fertilizer composition comprises a phosphate source.

Aspect 13: The fertilizer composition of aspect 12, wherein the phosphate source comprises a monoammonium phosphate-based phosphate or diammonium phosphate-based phosphate, or a combination thereof.

Aspect 14: The fertilizer composition of any one of aspects 1-13, wherein the fertilizer composition comprises calcium sulfate or ammonium sulfate or a combination thereof.

Aspect 15: The fertilizer composition of any one of aspects 1 and 3-14, comprising:
a) two or more nitrogen compounds, wherein two of the two or more nitrogen compounds are an ammoniacal nitrogen source and a nitrate nitrogen source,
b) one or more phosphorus compounds, wherein one of the one or more phosphorus compounds is a phosphate source,
c) one or more sulfur compounds, wherein one of the one or more sulfur compounds is calcium sulfate or ammonium sulfate,
d) potassium oxide, and
e) a filler, wherein the filler comprises single superphosphate or triple superphosphate or a combination thereof.

Aspect 16: The fertilizer composition of any one of aspects 2-14, wherein the sulfur compound is the same as one of the one or more nitrogen compounds.

Aspect 17: The fertilizer composition of any one of aspects 2-14, wherein the sulfur compound is calcium sulfate.

Aspect 18: The fertilizer composition of any one of aspects 1-17, further comprising a micronutrient.

Aspect 19: The fertilizer composition of any one of aspects 1-18, wherein the fertilizer composition does not comprise diammonium phosphate (DAP).

Aspect 20: The fertilizer composition of any one of aspects 1-19, wherein the filler does not comprise gypsum.

Aspect 21: The fertilizer composition of any one of aspects 1-20, wherein the fertilizer composition does not comprise gypsum.

Aspect 22: The fertilizer composition of any one of aspects 1-21, wherein the fertilizer composition exhibits a pH ranging from 3-5.

Aspect 23: The fertilizer composition of any one of aspects 1-22, wherein the fertilizer composition comprises a trace element comprising iron, zinc, copper, or manganese, or a combination thereof.

Aspect 24: The fertilizer composition of any one of aspects 1-23, wherein the fertilizer composition is substantially free of chlorine.

Aspect 25: The fertilizer composition of any one of aspects 1-24, wherein the fertilizer composition comprises a trace element in an amount ranging from 1 wt % to 15 wt % based on the total fertilizer composition.

Aspect 26: The fertilizer composition of any one of aspects 1-25, wherein the single superphosphate or triple superphosphate is the same as the phosphorus compound or the one or more phosphorus compounds.

Aspect 27: The fertilizer composition of any one of aspects 1-25, wherein the single superphosphate or triple superphosphate is different than the phosphorus compound or the one or more phosphorus compounds.

Aspect 28: A fertilizer composition comprising:
a) a fertilizer comprising a nitrogen compound, a phosphorus compound, a sulfur compound, and one or more potassium compounds, wherein one of the one or more potassium compounds is potassium nitrate, and
b) a filler, wherein the filler comprises gypsum.

Aspect 29: The fertilizer composition of aspect 28, wherein the fertilizer composition does not comprise potassium chloride or potassium sulfate.

Aspect 30: The fertilizer composition of aspects 28 or 29, wherein the fertilizer composition comprises an ammoniacal nitrogen source or a nitrate nitrogen source.

Aspect 31: The fertilizer composition of aspect 30, wherein the fertilizer composition comprises an ammoniacal nitrogen source that comprises monoammonium phosphate-based ammoniacal nitrogen, diammonium phosphate-based ammoniacal nitrogen, or ammonium sulfate-based ammoniacal nitrogen, or a combination thereof.

Aspect 32: The fertilizer composition of any one of aspects 28-31, wherein the fertilizer composition comprises a phosphate source.

Aspect 33: The fertilizer composition of aspect 32, wherein the phosphate source comprises a monoammonium phosphate-based phosphate or diammonium phosphate-based phosphate, or a combination thereof.

Aspect 34: The fertilizer composition of any one of aspects 28-33, wherein the fertilizer composition comprises calcium sulfate or ammonium sulfate or a combination thereof.

Aspect 35: The fertilizer composition of any one of aspects 28-34 comprising:
a) two or more nitrogen compounds, wherein two of the two or more nitrogen compounds are an ammoniacal nitrogen source and a nitrate nitrogen source, wherein the nitrate nitrogen is not potassium nitrate,
b) one or more phosphorus compounds, wherein one of the one or more phosphorus compounds is a phosphate source,
c) one or more sulfur compounds, wherein one of the one or more sulfur compounds is calcium sulfate or ammonium sulfate,
d) potassium nitrate, and
e) gypsum.

Aspect 36: The fertilizer composition of any one of aspects 28-35, further comprising a micronutrient.

Aspect 37: The fertilizer composition of any one of aspects 1-36, comprising
monoammonium phosphate-based NPK Grade 12-12-17 fertilizer,
diammonium phosphate-based NPK Grade 12-12-17 fertilizer,
monoammonium phosphate-based NPK Grade 15-15-15 fertilizer,
diammonium phosphate-based NPK Grade 15-15-15 fertilizer,
diammonium phosphate-based NPK 16-16-16 Grade fertilizer, and
diammonium phosphate-based NPK 18-18-5 Grade fertilizer.

Aspect 38: A method for producing a fertilizer composition comprising ammonium sulfate comprising:
a) supplying a mixture of sulfuric acid and phosphoric acid; and
b) adding ammonia and phosphate rock to the mixture, thereby forming single superphosphate or triple superphosphate or a combination thereof and in-situ ammonium sulfate.

Aspect 39: A method for producing a fertilizer composition comprising ammonium sulfate comprising:
a) supplying a mixture of sulfuric acid and phosphoric acid; and
b) adding ammonia to the mixture, thereby forming mono-ammonium phosphate (MAP) and in-situ ammonium sulfate.

Aspect 40: The method of aspects 38 or 39, wherein the in-situ ammonium sulfate is from 80 wt % to 100 wt % of the ammonium sulfate in the fertilizer composition.

Aspect 41: The method of any one of aspects 38-40, wherein the formation of the in-situ ammonium sulfate generates an amount of heat operable to produce a set of conditions in a granulator to produce a granule with a diameter ranging from 2 mm to 4.5 mm in size.

Aspect 42: The method of any one of aspects 38-41, wherein the method further comprises granulating the fertilizer into a granule with a diameter ranging from 2 mm to 4.5 mm in size.

Aspect 43: The method of aspects 42, wherein the granulation step occurs after step b.

Aspect 44: The method of any one of aspects 38-43, wherein the in-situ ammonium sulfate is formed in a pipe reactor or a pre-neutralizer.

Aspect 45: The method of any one of aspects 38-44, wherein the ammonium sulfate comprises solid ammonium sulfate and in-situ ammonium sulfate.

Aspect 46: The method of any one of aspects 38-45, wherein the method does not comprise forming diammonium phosphate (DAP).

Aspect 47: The method of any one of aspects 38-46, wherein the fertilizer composition exhibits a pH ranging from 3-5.

Aspect 48: The method of any one of aspects 38-47, wherein the method does not comprise forming a water insoluble phosphorus.

Aspect 49: The method of any one of aspects 38-48, wherein the method comprises adding a filler.

Aspect 50: The method of any one of aspects 38-49, wherein the filler does not comprise gypsum.

Aspect 51: The method of any one of aspects 38-50, wherein the fertilizer composition does not comprise gypsum.

Aspect 52: The method of any one of aspects 38-51, wherein the method comprises producing a slurry.

Aspect 53: The method of any one of aspects 38-52, wherein the method further comprises adding a potassium compound, a sulfur compound, or a phosphorus compound, or a combination thereof.

Aspect 54: The method of any one of aspects 38-53, wherein the method further comprises adding a potassium compound.

Aspect 55: The method of any one of aspects 38-54, wherein the method does not comprise adding potassium chloride or potassium sulfate.

Aspect 56: The method of any one of aspects 38-55, wherein the method comprises adding an ammoniacal nitrogen source or a nitrate nitrogen source.

Aspect 57: The method of aspect 56, wherein the ammoniacal nitrogen source comprises monoammonium phosphate-based ammoniacal nitrogen, diammonium phosphate-based ammoniacal nitrogen, or ammonium sulfate-based ammoniacal nitrogen, or a combination thereof.

Aspect 58: The method of any one of aspects 38-57, wherein the method comprises adding a phosphate source.

Aspect 59: The method of any one of aspects 58, wherein the phosphate source comprises a monoammonium phosphate-based phosphate or diammonium phosphate-based phosphate, or a combination thereof.

Aspect 60: The method of any one of aspects 38-59, wherein the method comprises adding calcium sulfate or ammonium sulfate or a combination thereof.

Aspect 61: The method of any one of aspects 38-60, wherein the fertilizer composition comprises a trace element comprising iron, zinc, copper, or manganese, or a combination thereof.

Aspect 62: The method of aspect 61, wherein the trace element is chelated or sulfated or both.

Aspect 63: The method of any one of aspects 38-62, wherein the method does not comprise adding an urea-based nitrogen.

Aspect 64: The method of aspect 38-63, wherein the fertilizer composition is substantially free of chlorine.

Aspect 65: The method of any one of aspects 38-64, wherein the fertilizer composition comprises a trace element in an amount ranging from 1 wt % to 15 wt % based on the total fertilizer composition.

Aspect 66: The method of any one of aspects 38-65, wherein the wherein the filler comprises one or more phosphorus compounds.

Aspect 67: The method of any one of aspects 38-66, wherein the filler does not comprises one or more phosphorus compounds.

Aspect 68: The product made by any one of aspects 38-67.

Aspect 69: A method of using the fertilizer composition of any one of aspects 1-27 and 68, comprising contacting the composition of any one of aspects 1-27 and 68 with a plant or soil.

Aspect 70: The method of using the fertilizer composition of aspect 69, further comprising contacting the plant or soil with water.

Aspect 71: A method for preparing a fertilizer composition comprising:
a) providing a fertilizer comprising a nitrogen compound, a phosphorus compound, a sulfur compound, and one or more potassium compounds, wherein one of the one or more potassium compounds is potassium nitrate,
b) adding a filler to the fertilizer, wherein the filler comprises gypsum, to form the fertilizer composition.

Aspect 72: The method of aspect 71, wherein the nitrogen compound and phosphorus compound is a substantially anhydrous ammonium phosphate/ammonium sulfate slurry formed by mixing anhydrous ammonia, sulfuric acid, and phosphoric acid, and substantially driving off water.

Aspect 73: The method of aspects 71 or 72 wherein the potassium nitrate is crystalline potassium nitrate.

Aspect 74: The method of aspect 73, wherein the ammonium phosphate part of the ammonium phosphate/ammonium sulfate slurry is substantially monoammonium phosphate or diammonium phosphate.

Aspect 75: The method of aspect 74, wherein the monoammonium phosphate or diammonium phosphate is made by combining ammonia and phosphoric acid in a mole ratio of from 1:1 to 1.4:1.

Aspect 76: The method of any one of aspects 71-75, further comprising mixing crystalline ammonium sulfate with the ammonia and the phosphoric acid to produce the substantially anhydrous monoammonium phosphate/ammonium sulfate slurry or anhydrous diammonium phosphate/ammonium sulfate slurry.

Aspect 77: The method of aspect 76, wherein the temperature of the substantially anhydrous monoammonium phosphate/ammonium sulfate slurry or anhydrous diammonium phosphate/ammonium sulfate slurry is between about 85° C. and about 135° C.

Aspect 78: The method of any one of aspects 71-77, wherein the method further comprises granulating the fertilizer composition.

Aspect 79: The method for preparing a fertilizer composition of any one of aspects 71-78, comprising:
a) providing a fertilizer comprising a substantially anhydrous monoammonium phosphate/ammonium sulfate slurry or anhydrous diammonium phosphate/ammonium sulfate slurry;
b) mixing the fertilizer, gypsum, and crystalline potassium nitrate to form the fertilizer composition; and
c) granulating the fertilizer composition.

Aspect 80: The method for preparing a fertilizer composition of any one of aspects 71-79, comprising:
a) providing a fertilizer comprising a substantially anhydrous monoammonium phosphate/ammonium sulfate slurry or anhydrous diammonium phosphate/ammonium sulfate slurry, phosphoric acid, sulfuric acid, and crystalline ammonium sulfate and substantially driving off water;
b) mixing the fertilizer, gypsum, and crystalline potassium nitrate to form the fertilizer composition; and
c) granulating the fertilizer composition.

Aspect 81: The method for preparing a fertilizer composition of any one of aspects 71-80, further comprising mixing the composition, the filler, and the potassium compound with micronutrients.

Aspect 82: The product made by the method of any one of aspects 71-81.

Aspect 83: The granulated fertilizer composition product of aspect 82, comprising
monoammonium phosphate-based NPK Grade 12-12-17 fertilizer,
diammonium phosphate-based NPK Grade 12-12-17 fertilizer,
monoammonium phosphate-based NPK Grade 15-15-15 fertilizer,
diammonium phosphate-based NPK Grade 15-15-15 fertilizer,
diammonium phosphate-based NPK 16-16-16 Grade fertilizer, or
diammonium phosphate-based NPK 18-18-5 Grade fertilizer.

Aspect 84: A method of using the fertilizer composition of any one of aspects 28-37, 82 and 83, comprising contacting the composition of any one of aspects 28-37, 82 and 83 with a plant or soil.

Aspect 85: The method of using the fertilizer composition of aspect 84, further comprising contacting the plant or soil with water.

### G. Experimental

The following examples are put forth so as to provide those of ordinary skill in the art with a complete disclosure and description of how the compositions and/or methods claimed herein are made and evaluated, and are intended to be purely exemplary of the invention and are not intended to limit the scope of what the inventors regard as their invention. Efforts have been made to ensure accuracy with respect to numbers (for example, amounts and temperatures), but some errors and deviations should be accounted for. Unless indicated otherwise, parts are parts by weight, temperature is in ° C. or is at ambient temperature, and pressure is at or near atmospheric.

Several methods for preparing the compositions of the present invention are illustrated in the following examples. Starting materials and the requisite intermediates are in some cases commercially available, or can be prepared according to literature procedures or as illustrated herein.

The following exemplary compositions of the invention were prepared. The examples are provided herein to illustrate the invention, and should not be construed as limiting the invention in any way.

### 1. GENERAL METHODS

The release of heat from the reaction between ammonia, phosphoric acid, and sulfuric acid produced a hot melt comprising ammonium phosphate and ammonium sulfate, which can be used instead of, or in addition to, steam to cause granulation. The PCR comprised a horizontal reaction tube mounted on the inside of a rotary ammonization-granulation drum. A liquid feed entered the reaction tube outside of the granulator and flowed toward the discharge end. Ammonia entered through another tube at the feed end of the reactor and discharged a certain distance from the feed end of the reactor. Sulfuric acid and phosphoric acid were introduced through lines installed perpendicular to the reactor. These feed lines formed a “cross’ from which the name originates. Water could optionally be added to the ammonia prior to its addition to the reactor to introduce a smoother reaction between the ammonia and the acids. Reaction of these materials within such a confined area retained much of the chemical heat of reaction. Water that was present in the reactor substantially vaporized, flashed off at the pipe's discharge, and was removed in the exhaust gases from the granulator. The temperature of the substantially anhydrous (i.e., without water) melt was above its melting point when it was discharged onto the rolling bed of material comprising a plurality of crystalline potassium nitrate granules in the granulator. Substantial moisture removal from the product occurred during granulation as the product cooled, resulting in a product mixture with a substantially low moisture content.

Starting materials were transferred by a materials bucket to a cluster hopper comprising a weigh hopper and a surge hopper. The cluster hopper had an open grate top cover, a holding capacity of six metric tons, and six compartments with clamshell-type duplex discharge gates at the bottom of each and levers and linkages for manual operation. The weigh hopper was mounted on a 500 Kg scale with a 3 metric ton gross capacity, a floor-mounted scale dial graduated in kilograms, and a clamshell duplex discharge gate with levers and linkages for manual operation. The surge hopper was mounted on a variable-speed, 3 meter-long screw conveyor with a 5,000 Kg/hour conveying capacity and a 1,000 Kg holding capacity. The screw conveyor included a totally-enclosed, fan-cooled variable-speed two-horsepower motor. Materials from the weigh hopper entered the surge hopper and, once weighed, were fed by the screw conveyor that discharged into the boot of the granulator feed bucket elevator, which, in turn, discharged into the granulator.

Merchant-grade phosphoric acid, circulated using a centrifugal pump to keep insoluble materials suspended, was transferred from stainless steel, cone bottomed storage tanks to a 1,300 L stainless steel feed tank. The centrifugal pump was also used to transfer the phosphoric acid from the feed tank to the pipe-cross reactor and to reticulate the acid in the tank to prevent settling. The phosphoric acid fed into the PCR cross at a 90° angle from an anhydrous ammonia feed. The PCR was used to make the ammonium phosphate/ammonium sulfate slurry. Sulfuric acid was pumped into the PCR through a Grade 316 L stainless steel, 1.3 cm in diameter pipe using a Milroy dual piston pump. The sulfuric acid flow rate was measured manually with a scale and a stopwatch before and after plant operations. During a run, the drum was placed on a scale, and feed rate into the PCR was calculated every 30 minutes by weight loss. The sulfuric acid feed line was also connected on one side of the PCR cross at a 90° angle from the anhydrous ammonia feed. Anhydrous ammonia was fed through an ammonia injector into the PCR cross along the horizontal axis of the pipe. Water was added through an injector to control reaction temperature inside the PCR and measured using a magnetic flow meter.

The PCR was made from Hastelloy® C-276, a Ni—Mo—Cr alloy with tungsten. The cross was a 121 mm by 67 mm thick square-type with four 38 mm openings. The pipe was 266.7 cm long and 3.81 cm in diameter and had two 9 5 mm discharge parts that were 102 mm apart, starting 17.8 mm from the discharge end. The ammonia injector was made from 1.9-cm in diameter Hastelloy® C-276 pipe, which extended 5.1 cm into the pipe.

Thermocouples were installed on PCR the surface to measure surface temperature and to develop a temperature profile of the PCR. Three pair (six total) of thermocouples (three on the top side and three on the bottom side of the PCR) were installed to measure and monitor temperatures that were generated along the length of the PCR. The thermocouples were located at 45.7 cm, 121.9 cm, and 198 cm from the cross. Average temperatures recorded by the thermocouples during each process run ranged from about 85° C. to about 140° C.

The ammonium phosphate/ammonium sulfate slurry was discharged from the PCR into a rotary-type, 180 cm long and 92 cm in diameter drum granulator with a 15 cm retaining dam located 25.4 cm from its discharge end. Samples of PCR discharge were taken at the discharge end to monitor the slurry pH and mole ratios every 30 minutes during the process.

Gaseous ammonia was fed into the granulator through a drilled stainless steel pipe sparger submerged under a rolling bed of material in the granulator. Recycled material was fed into the granulator from the screening system. This material consisted of the undersize fraction and some product-size material from the screens. Gases drawn from the granulator area passed through a venture-type scrubber using water as a scrubbing media. The scrubbing system comprised a polyester venture-type scrubber, a Grade 316 L stainless steel recirculation tank with a capacity of approximately 300 L, a recirculation pump, and a Grade 316 L stainless steel fan.

Moist material from the granulator was discharged by gravity into a rotary dryer 7.3 m long and 92 cm in diameter. The dryer was operated with a co-current airflow heated using a natural gas-fired combustion chamber located in line with the material inlet of the dryer. The operating temperature of the dryer was controlled indirectly by measuring the temperature of the dryer discharge material and adjusting combustion chamber temperature accordingly. The dryer was operated at a rotational speed of between 7 and 8 revolutions per minute.

A 76.2 cm in diameter by 488 cm tall cyclone-type dust collector was located in a process air duct between a 36 cm in diameter dryer discharge and exhaust fan. The cyclone was constructed from mild steel plate with a thickness of 0.5 cm. A Grade 316 L stainless steel, open-wheel centrifugal fan discharged exhaust air.

A centrifugal-type bucket elevator transferred material from the dryer discharge to an inclined, double-deck, mechanically vibrated screening system. The screen housing was fitted with a Ty-Rod oversize screen (4.75 mm opening) and a Ty-Rod undersize screen (2.36 mm opening) to produce product material between about 2.36 mm and 4.75 mm. Oversize material from the screening system was routed to a chain mill. The crushed material discharging from the chain mill was returned to the screening system. Undersize material from the screening system was returned to the granulator together with a controlled fraction of product size material to maintain optimum granulation. The product-size fraction from the screening system was fed into the rotary cooler. The pilot plant also had a 36 cm in diameter cyclone-type fugitive dust collection system and a 76.2 cm in diameter and 488 cm tall cyclone, both constructed from mild 0.5 cm steel plate. A 316L stainless steel, open-wheel centrifugal fan discharged exhaust.

Process equipment in the pilot plant was made from mild steel, with the exception of the PCR and venturi-type scrubber and its auxiliary tanks and equipment. The mild steel components were coated with zinc-epoxy corrosion-resistant resin. The equipment interior was not coated. Product-sized material was collected in 1 metric ton-capacity portable bins. Composite samples of product from each test were evaluated to determine chemical fertilizer composition and selected physical properties. In addition, samples from different process steams were taken during each test and submitted for chemical analyses.

### 2. EXAMPLES 1 AND 2

Preparation of MAP-Based NPK Grade 12-12-17 Fertilizer with Micronutrients From 100 wt % Crystalline AS

For the starting materials in examples 1 and 2, see Table 1.

The ratio between crystalline and made in situ AS in this run was 100-0. Micronutrients were incorporated into the process as compound basis ratio 3:2:1:1 of 1.5 wt % of the final product. Feed rates of phosphoric acid and ammonia to the PCR were steady, and water was not added to the PCR because of the low temperature. Ammonia, water, and steam were added under the bed of material in the drum granulator during the run. The recycle-to-product ratio averaged 7:1, and granulator discharge material temperature averaged 80° C. Granulator discharge material moisture content averaged 3%, and granulator discharge material NH₃:H₃PO₄ mole ratio averaged 1.8. Material buildup was observed inside the dryer and the dryer discharge material temperature averaged 97° C.

### 3. EXAMPLE 3

Preparation of MAP-Based NPK Grade 12-12-17 Fertilizer From 30 wt % Crystalline AS/70 wt % in situ AS

For the starting materials in example 3, see Table 1.

The ratio between crystalline and made in situ AS in this run was 30-70. Sulfuric acid was added to the drum granulator. Feed rates of phosphoric acid and ammonia to the PCR during the run were steady. Addition of water to the PCR was not needed because of the low temperature, with the hottest point having an average value of 115° C. The sulfuric acid feed rate to the granulator was steady Ammonia and water were added under the bed of material in the drum granulator during the run, but steam was not. The recycle-to-product ratio averaged 7:1, and granulator discharge material temperature averaged 79° C. The granulator discharge material content averaged 3%, and the granulator discharge material NH₃:H₃PO₄ mole ratio averaged 1.8. Material buildup was noticed on the lifting flights of the dryer, and large lumps of material were collected from the dryer discharge throughout the day. The dryer discharge internal temperature averaged 86° C.

### 4. EXAMPLE 4

Preparation of MAP-Based NPK Grade 12-12-17 Fertilizer With Micronutrients From 30 wt % Crystalline AS/70 wt % in situ AS

For the starting materials in example 4, see Table 1.

The ratio between crystalline and made in situ AS in this run was 30-70. Micronutrients added as compound basis ratio Iron:Zinc:Magnesium:Copper 3:2:1:1 of 1.5 wt % of the final product were incorporated into the process. Sulfuric acid was added steadily to the drum granulator but not to the PCR. Feed rates of phosphoric acid and ammonia to the PCR during the run were steady. No additional water was added to the PCR due to low temperature. Ammonia, water, and steam were added under the bed of material in the drum granulator during the run. The recycle-to-product ratio averaged 7:1, and granulator discharge material temperature averaged 86° C. Granulator discharge material moisture content averaged 3%, and granulator discharge material temperature averaged 90° C. Product samples collected during the run caked, resulting in a hard mass.

### 5. EXAMPLE 5

DAP-Based NPK Grade 12-12-17 Fertilizer From 30 wt % Crystalline AS/70 wt % in situ AS

For the starting materials in example 5, see Table 1.

The ratio between crystalline and made in situ AS in this run was 30-70. The feed rates of ammonia and phosphoric acid to the PCR fluctuated during the run, resulting in significant back pressure. The average NH₃:H₃PO₄ mole ratio of the PCR was 1:1. Ammonia, water, and steam were added under the bed of material in the drum granulator during the run. The recycle-to-product ratio averaged 7:1, and granulator discharge material temperature averaged 71° C. Granulator discharge material moisture content averaged 2.1%, and the granulator discharge material NH₃:H₃PO₄ mole ratio averaged 1.77. No material buildup was observed inside the dryer, and the discharge material temperature averaged 89° C. Product at the end of this run showed some caking.

### 6. EXAMPLE 6

DAP-Based NPK Grade 12-12-17 Fertilizer From 30 wt % Crystalline AS/70 wt % in situ AS

For the starting materials in example 6, see Table 1.

The ratio between crystalline and made in situ AS in this run was 30-70. The feed rate of phosphoric acid to the PCR fluctuated during this run, perhaps due to addition of sulfuric acid through the same line, and resulted in significant back pressure. The average NH₃:H₃PO₄ mole ratio of the PCR was 1:1. Ammonia, water, and steam were added under the bed of material in the drum granulator during the run. The recycle-to-product ratio averaged 7:1, and granulator discharge material temperature averaged 78° C. Granulator discharge material moisture content averaged 2.5%, and the granulator discharge material NH₃:H₃PO₄ mole ratio averaged 1.73. No material buildup was observed inside the dryer, and the discharge material temperature averaged 90° C. Product at the end of this run also showed some caking.

### 7. EXAMPLE 7

MAP-Based NPK Grade 15-15-15 Fertilizer With Micronutrients From 100 wt % Crystalline AS

For the starting materials in example 7, see Table 2.

The ratio between crystalline and made in situ AS in this run was 100-0. Micronutrients were added as compound basis ratio Iron:Zinc:Magnesium:Copper 3:2:1:1 of 1.5 wt % of the final product were incorporated into the process. Some product caking was observed during the run and was attributed to the presence of the micronutrients. The feed rates of phosphoric acid and ammonia to the PCR were steady during the run. Water was not added to the PCR due to low temperature. Ammonia, water, and steam were added under the granulator bed during the run. The recycle-to-product ratio averaged 8:1, and granulator discharge material temperature averaged 81° C. Granulator discharge material moisture content averaged 3%, and the granulator discharge material NH₃:H₃PO₄ mole ratio averaged 1.75. Material buildup was observed inside the dryer, and large amounts of discharge material with an average temperature of 94° C. were collected therefrom.

### 8. EXAMPLE 8

DAP-Based NPK Grade 15-15-15 Fertilizer From 100 wt % Crystalline AS

For the starting materials in example 8, see Table 8.

The ratio between crystalline and made in situ AS in this run was 100-0. Granulator discharge material moisture content averaged 3.5%, granulator discharge material temperature averaged 3.5%, and discharge material temperature averaged 94° C.

### 9. EXAMPLE 9

DAP-Based NPK Grade 15-15-15 Fertilizer From 50 wt % Crystalline AS/50 wt % in situ AS

For the starting materials in example 9, see Table 2.

The ratio between crystalline and made in situ AS in this run was 50-50. The feed rate of phosphoric acid to the PCR fluctuated during the run, resulting in significant back pressure, and may have been caused by addition of sulfuric acid through the same line. The ammonia feed rate to the PCR also varied during the run. The average NH₃:H₃PO₄ mole ratio of the PCR was 1.15 Ammonia, water, and steam were added under the bed of material in the granulator during the run. The recycle-to-product ratio averaged 7:1, and the granulator discharge material temperature averaged 77° C. The granulator discharge material moisture content averaged 2.0%, and the granulator discharge material NH₃:H₃PO₄ mole ratio averaged 1.81. There was no material buildup inside the dryer, and the discharge material temperature averaged 86° C.

### 10. EXAMPLE 10

DAP-Based NPK 16-16-16 Grade Fertilizer From 50 wt % Crystalline AS/50 wt % in situ AS

For the starting materials in example 10, see Table 3.

The ratio between crystalline and made in situ AS in this run was 50-50. The feed rate of phosphoric acid to the PCR fluctuated during the run, resulting in significant back pressure, and may have been caused by addition of sulfuric acid through the same line. The ammonia feed rate to the PCR also varied during the run. The average NH₃:H₃PO₄ mole ratio of the PCR was 1.18 Ammonia and water were added under the bed of material in the granulator during the run, but steam was not. The recycle-to-product ratio averaged 8:1, and the granulator discharge material temperature averaged 79° C. The granulator discharge material moisture content averaged 2.3%, and the granulator discharge material NH₃:H₃PO₄ mole ratio averaged 1.82. There was no material buildup inside the dryer, and the discharge material temperature averaged 87° C.

### 11. EXAMPLE 11

DAP-Based NPK 16-16-16 Grade Fertilizer From 50 wt % Crystalline AS/50 wt % in situ AS

For the starting materials in example 11, see Table 3.

The ratio between crystalline and made in situ AS in this run was 50-50. The feed rate of phosphoric acid to the PCR fluctuated during the run, resulting in significant back pressure. The average NH₃:H₃PO₄ mole ratio of the PCR was 1.0. Ammonia, water, and steam were added under the bed of material in the granulator during the run. The recycle-to-product ratio averaged 8:1, and the granulator discharge material temperature averaged 80° C. The granulator discharge material moisture content averaged 2.4%, and the granulator discharge material NH₃:H₃PO₄ mole ratio averaged 1.8. There was no material buildup inside the dryer, the discharge material temperature averaged 85° C., and the product did not display any tendency to cake.

### 12. EXAMPLE 12, 13, AND 14

DAP-Based NPK 18-18-5 Grade Fertilizer From 70 wt % Crystalline AS/30 wt % in situ AS

For the starting materials in examples 12, 13, and 14, see Table 3.

The ratio between crystalline and made in situ AS in this run was 70-30. The feed rate of phosphoric acid to the PCR remained steady during the run, resulting in minimal back pressure. The average NH₃:H₃PO₄ mole ratio of the PCR was 1.3. Ammonia, water, and steam were added under the bed of material in the granulator during the run. The recycle-to-product ratio averaged 8:1, and the granulator discharge material temperature averaged 74° C. The granulator discharge material moisture content averaged 3.8%, and the granulator discharge material NH₃:H₃PO₄ mole ratio averaged 1.8. There was no material buildup inside the dryer, the discharge material temperature averaged 92° C., and the product did not cake.

Products were collected at five-minute intervals for one hour to produce average values. Analyses were performed according to the Association of Official Analytical Chemists (AOAC) methods, hereby incorporated herein by reference. Size analyses, abrasion resistance and granule crushing strength tests were conducted according to the procedures outlined in the Manual for Determining Physical Properties of Fertilizers, Publication R-(10), hereby incorporated herein by reference in its entirety for the test procedure. Analyses were performed on composite samples of end-of-run materials.

The average crushing values of MAP-based fertilizer compositions of the present invention ranged from about 0.8 kg/granule to about 3.6 kg/granule; and the average crushing values of DAP-based granules ranged from about 0.1.5 kg/granule to about 2.7 kg/granule, thereby demonstrating utility of fertilizer compositions of the present invention as having excellent resistance to crushing forces.

Analyses performed from product samples of the fertilizer compositions showed that product size was consistent throughout the process with minor variations in size distribution. The fertilizer compositions had UI values of about 50 and SGNs that ranged from about 262 to about 402, which translated to between about 2.62 mm and about 4.02 mm.

Abrasion resistance test values obtained from product samples of the fertilizer compositions ranged from about 0.1 wt % degradation to about 2.0 wt % degradation. Abrasion resistance test values obtained for DAP-based products ranged between about 0.1 wt % to about 0.2 wt % degradation.

Bulk densities of the fertilizer compositions ranged between about 892 kg/m³ and about 1,047 kg/m³.

The critical relative humidity for the fertilizer compositions ranged narrowly and predictably from about 70 wt % to about 75%, except for DAP-Based NPK 18-18-5 Grade fertilizer prepared from 70 wt % crystalline AS/30 wt % in situ AS, whose CRH ranged narrowly and predictably from about 65 wt % to about 70 wt %.

The fertilizer compositions resulted in “fair” to “good” granule integrity after the moisture absorption-penetration test.

Flowability determination was made by recording elapsed times for 25%, 50%, and 75% flowability, and demonstrated sufficient flowability rates of the fertilizer compositions.

TABLE 1
Single-Run MAP-Based and DAP-Based NPK 12-12-17 Grade Fertilizer Production Data

| | Example (Ex.) | | | | | |
|---|---|---|---|---|---|---|
| | Ex. 1/Ex. 2 (MAP) | | Ex. 3/Ex. 4 (MAP) | | Ex. 5/Ex. 6 (DAP) | |
| Crystalline/in situ AS ratio | 100-0 | | 30-70 | | 30-70 | |
| Pipe-Cross Reactor | | | | | | |
| Feeds (Kg/h) | | | | | | |
| Phosphoric acid | 85.7 | 89.3 | 68.5 | 69.0 | 67.7 | 67.5 |
| Sulfuric acid | 0.0 | 0.0 | 0.0 | 0.0 | 17.2 | 16.5 |
| Ammonia | 6.0 | 6.0 | 5.5 | 6.0 | 19.0 | 19.0 |
| Water | 0.0 | 0.0 | 0.0 | 0.0 | 26.2 | 24.3 |
| Conditions | | | | | | |
| Pipe surface temperature (° C.) | | | | | | |
| 45.7 cm from cross | 52 | 65 | 85 | 40 | 107 | 106 |
| 121.9 cm from cross | 120 | 116 | 90 | 120 | 124 | 122 |
| 198.1 cm from cross | 116 | 121 | 115 | 112 | 130 | 125 |
| Slurry NH₃:H₃PO₄ mole ratio | 0.55 | 0.52 | 0.58 | 0.55 | 1.10 | 1.05 |
| Slurry pH | 2.0 | 2.2 | 2.2 | 2.1 | 5.0 | 3.8 |
| Drum Granulator | | | | | | |
| Feeds (Kg/h) | | | | | | |
| Sulfuric acid | 0.0 | 0.0 | 34.3 | 34.3 | 0.0 | 0.0 |
| Potassium nitrate | 149.8 | 149.8 | 112.4 | 112.4 | 112.4 | 112.4 |
| Ammonium sulfate | 85.8 | 85.8 | 19.2 | 19.2 | 9.2 | 9.2 |
| Gypsum | 75.0 | 75.0 | 61.6 | 57.2 | 86.4 | 86.4 |
| Ferric sulfate | 2.6 | 2.6 | 0.0 | 2.0 | 0.0 | 0.0 |
| Manganese sulfate | 0.9 | 0.9 | 0.0 | 0.7 | 0.0 | 0.0 |
| Zinc sulfate | 1.9 | 1.9 | 0.0 | 1.3 | 0.0 | 0.0 |
| Copper sulfate | 0.9 | 0.9 | 0.0 | 0.7 | 0.0 | 0.0 |
| Ammonia | 9.5 | 10.9 | 21.0 | 20.0 | 21.9 | 24.7 |
| Steam | 19.0 | 19.0 | 0.0 | 13.9 | 10.0 | 11.3 |
| Water | 42.1 | 47.8 | 63.4 | 39.3 | 36.5 | 36.5 |
| Conditions | | | | | | |
| Bed temperature (° C.) | 78 | 80 | 79 | 86 | 71 | 78 |
| Recycle temperature (° C.) | 73 | 75 | 70 | 69 | 81 | 70 |
| Granulator discharge pH | 4.6 | 4.4 | 5.0 | 4.8 | 7.4 | 7.2 |
| Granulator discharge | 1.0 | 1.0 | 1.1 | 1.1 | 1.8 | 1.7 |
| NH₃:H₃PO₄ mole ratio | | | | | | |
| Recycle-to-product ratio | 6 | 7 | 7 | 7 | 7 | 8 |
| Rotational speed (rpm) | 17 | 16 | 17 | 16 | 19 | 18 |
| Drum speed (% fraction of critical) | 39 | 36 | 38 | 37 | 43 | 41 |
| Dryer | | | | | | |
| Conditions | | | | | | |
| Throughput (Kg/h) | 3,032 | 3,245 | 2,687 | 2,876 | 2,471 | 2,647 |
| Airflow (Am³/h) | 2,874 | 2,784 | 2,624 | 2,828 | 2,687 | 2,935 |
| Rotational speed (rpm) | 7 | 7 | 7 | 7 | 7 | 7 |
| Combustion chamber Temp. (° C.) | 380 | 490 | 340 | 330 | 280 | 310 |
| Material discharge temperature (° C.) | 92 | 97 | 86 | 90 | 89 | 90 |
| Exhaust air temperature (° C.) | 87 | 94 | 80 | 83 | 80 | 85 |
| Product Cooler | | | | | | |
| Conditions | | | | | | |
| Materials discharge temperature (° C.) | 54 | 63 | 50 | 49 | 55 | 54 |
| Ambient Conditions During Process | | | | | | |
| Relative humidity (min./max.), (%) | 61/65 | 42/78 | 60/87 | 87/max. | 61/82 | 72/max. |
| Temperature (min./max.) (° C.) | 28/29 | 27/31 | 28/23 | 29/35 | 30/33 | 29/33 |

TABLE 2
Single-Run MAP-Based and DAP-Based NPK 15-15-15
Grade Fertilizers Production Data

| | Example | | |
|---|---|---|---|
| | Ex. 7 | Ex. 8 | Ex. 9 |
| Crystalline/in situ AS ratio | 100-0 | 100-0 | 50-50 |
| | (MAP) | (DAP) | (DAP) |
| Pipe-Cross Reactor | | | |
| Feeds (Kg/h) | | | |
| Phosphoric acid | 97.6 | 84.8 | 86.2 |
| Sulfuric acid | 0.0 | 0.0 | 0.0 |
| Ammonia | 7.0 | 17.0 | 26.0 |
| Water | 0.0 | 30.0 | 41.4 |
| Conditions | | | |
| Pipe surface temperature (° C.) | | | |
| 45.7 cm from cross | 56 | 76 | 106 |
| 121.9 cm from cross | 112 | 95 | 122 |
| 198.1 cm from cross | 121 | 110 | 124 |
| Slurry NH₃:H₃PO₄ mole ratio | 0.54 | 1.35 | 1.15 |
| Slurry pH | 2.1 | 6.4 | 5.5 |
| Drum Granulator | | | |
| Feeds (Kg/h) | | | |
| Sulfuric acid | 0.0 | 0.0 | 0.0 |
| Potassium nitrate | 115.6 | 99.2 | 99.2 |
| Ammonium sulfate | 124.8 | 66.8 | 33.6 |
| Gypsum | 25.0 | 46.6 | 46.6 |
| Ammonia | 10.9 | 24.7 | 24.7 |
| Steam | 19.0 | 18.0 | 7.3 |
| Water | 42.1 | 33.6 | 33.6 |
| Conditions | | | |
| Bed temperature (° C.) | 81 | 79 | 77 |
| Recycle temperature (° C.) | 75 | 68 | 81 |
| Granulator discharge pH | 4.9 | 7.2 | 7.4 |
| Granulator discharge | 1.0 | 1.8 | 1.8 |
| NH₃:H₃PO₄ mole ratio | | | |
| Recycle-to-product ratio | 9 | 7 | 7 |
| Rotational speed (rpm) | 17 | 18 | 19 |
| Drum speed (% fraction of critical) | 38 | 41 | 43 |
| Dryer | | | |
| Conditions | | | |
| Throughput (Kg/h) | 3,323 | 2,687 | 2,965 |
| Airflow (Am³/h) | 2,624 | 2,828 | 2,874 |
| Rotational speed (rpm) | 7 | 7 | 7 |
| Combustion chamber Temp. (° C.) | 430 | 310 | 238 |
| Material discharge temperature (° C.) | 94 | 85 | 86 |
| Exhaust air temperature (° C.) | 87 | 78 | 75 |
| Product Cooler | | | |
| Conditions | | | |
| Materials discharge temperature | 56 | 56 | 56 |
| (° C.) | | | |
| Ambient Conditions During Process | | | |
| Relative humidity (min./max.), (%) | 43/75 | 67/84 | 59/80 |
| Temperature (min./max.) (° C.) | 27/33 | 28/32 | 31/33 |

TABLE 3
Single-Run DAP-Based NPK 16-16-16 Grade Fertilizer Production Data
and
Single-Run DAP-Based NPK 18-18-5 Grade Fertilizer Production Data

| Article I. Example | Ex. 10/Ex. 11 | | Ex. 12/Ex. 13/Ex. 14 | | |
|---|---|---|---|---|---|
| Crystalline/in situ | Article II. 50-50 (DAP) | | | | |
| AS ratio | | | | | |
| Article III. Pipe- | | | | | |
| Cross | | | | | |
| Reactor | | | | | |
| Article IV. Feeds | 97.3 | 98.5 | 107.5 | 111.2 | 110.4 |
| (Kg/h) | | | | | |
| Phosphoric | 26.6 | Article V. | 30.4 | Article X. [symbol] | Article XI. [symbol] |
| acid | | 6.6 | | 0.4 | 0.4 |
| Sulfuric acid | Article VI. | Article VII. | Article XII. [symbol] | Article XIII. [symbol] | Article XIV. [symbol] |
| Ammonia | 6.0 | 6.0 | 8.0 | 0.0 | 0.0 |
| Water | Article VIII. | Article IX. | Article XV. [symbol] | Article XVI. [symbol] | Article XVII. [symbol] |
| | 1.4 | 1.9 | 5.2 | 3.3 | 3.3 |
| Article XVIII. Conditions | | | | | |
| Pipe surface | 103 | 101 | 115 | 118 | 120 |
| temperature (° C.) | 123 | Article XIX. | 121 | Article XXVI. | Article XXVII. |
| 45.7 cm | | 11 | | 22 | 21 |
| from cross | Article XX. | Article XXI. | Article XXVIII. | Article XXIX. | Article XXX. |
| 121.9 cm | 30 | 15 | 23 | 21 | 18 |
| from cross | Article XXII. | Article XXIII. | Article XXXI. | Article XXXII. | Article XXXIII. |
| 198.1 cm | .18 | .00 | .25 | .35 | .30 |
| from cross | Article XXIV. | Article XXV. | Article XXXIV. [symbol] | Article XXXV. [symbol] | Article XXXVI. [symbol] |
| Slurry | .8 | .5 | .0 | .3 | .1 |
| NH₃:H₃PO₄ mole | | | | | |
| ratio | | | | | |
| Slurry pH | | | | | |
| Article XXXVII. | | | | | |
| rum Granulator | | | | | |
| Article XXXVIII. | | | | | |
| eeds (Kg/h) | 0.0 | 0.0 | 0.0 | 0.0 | 0.0 |
| Sulfuric acid | 105.8 | Article XXXIX. | 33.2 | Article LI. [symbol] | Article LII. [symbol] |
| Potassium | | 05.8 | | 3.2 | 1.0 |
| nitrate | Article XL. | Article XLI. | Article LIII. [symbol] | Article LIV. [symbol] | Article LV. [symbol] |
| Ammonium | 4.6 | 4.6 | 3.2 | 3.2 | 3.2 |
| sulfate | Article XLII. | Article XLIII. | Article LVI. [symbol] | Article LVII. [symbol] | Article LVIII. [symbol] |
| Gypsum | 4.0 | 4.0 | 3.4 | 3.4 | 3.4 |
| Ammonia | Article XLIV. | Article XLV. | Article LIX. [symbol] | Article LX. [symbol] | Article LXI. [symbol] |
| Steam | 3.7 | 2.8 | 9.3 | 9.3 | 9.3 |
| Water | Article XLVI. | Article XLVII. | Article LXII. | Article LXIII. | Article LXIV. |
| | .0 | .0 | 3.0 | 2.5 | 1.0 |
| | Article XLVIII. | Article XLIX. | Article LXV. [symbol] | Article LXVI. [symbol] | Article LXVII. [symbol] |
| | 2.1 | 0.8 | 1.8 | 4.6 | 1.8 |
| | Article L. | | | | |
| Article LXVIII. Conditions | 79 | 80 | 79 | 79 | 74 |
| Bed | 72 | Article LXIX. | 73 | Article LXXX. [symbol] | Article LXXXI. [symbol] |
| temperature (° C.) | | 3 | | 6 | 3 |
| Recycle | Article LXX. | Article LXXI. | Article LXXXII. | Article LXXXIII | Article LXXXI [symbol] |
| temperature (° C.) | .4 | .3 | .4 | .7 | .5 |
| Granulator | | | | | |
| discharge pH | Article LXXII. | Article LXXIII. | Article LXXXV. | Article LXXXV [symbol] | Article LXXXV [symbol] |
| Granulator | .8 | .8 | .8 | .9 | .8 |
| discharge | Article LXXIV. | Article LXXV. | Article LXXXV [symbol] | Article LXXX [symbol] | Article XC. [symbol] |
| NH₃:H₃PO₄ | Article LXXVI. | Article LXXVII | Article XCI. | Article XCII. | Article XCIII. |
| mole ratio | 7 | 8 | 8 | 8 | 8 |
| Recycle-to- | Article LXXVII | Article LXXIX. | Article XCIV. [symbol] | Article XCV. [symbol] | Article XCVI. [symbol] |
| product ratio | 8 | 1 | 1 | 1 | 1 |
| Rotational | | | | | |
| speed (rpm) | | | | | |
| Drum speed (% | | | | | |
| fraction of | | | | | |
| critical) | | | | | |
| Article XCVII. Dryer | | | | | |
| Conditions | | | | | |
| Throughput | 2,654 | 2,835 | 2,765 | 2,897 | 2,678 |
| (Kg/h) | 2,828 | Article XCVIII. [symbol] | 2,987 | Article CVII. [symbol] | Article CVIII. [symbol] |
| Airflow | | ,874 | | ,895 | ,658 |
| (Am³/h) | Article XCIX. | Article C. [symbol] | Article CIX. | Article CX. [symbol] | Article CXI. [symbol] |
| Rotational | Article CI. | Article CII. [symbol] | Article CXII. | Article CXIII. [symbol] | Article CXIV. [symbol] |
| speed (rpm) | 55 | 45 | 80 | 55 | 70 |
| Combustion | Article CIII. | Article CIV. [symbol] | Article CXV. | Article CXVI. [symbol] | Article CXVII. [symbol] |
| chamber Temp. | 7 | 5 | 0 | 3 | 2 |
| (° C.) | Article CV. | Article CVI. [symbol] | Article CXVIII. | Article CXIX. [symbol] | Article CXX. [symbol] |
| Material | 0 | 9 | 4 | 7 | 8 |
| discharge | | | | | |
| temperature (° C.) | | | | | |
| Exhaust air | | | | | |
| temperature (° C.) | | | | | |
| Article CXXI. Product | | | | | |
| Cooler | | | | | |
| Article CXXII. Conditions | 56 | 57 | 60 | 57 | 60 |
| Materials | | | | | |
| discharge | | | | | |
| temperature (° C.) | | | | | |
| Article CXXIII. | | | | | |
| mbient | | | | | |
| Conditions | | | | | |
| During Process | | | | | |
| Article CXXIV. | Article CXXV. | 56/81 | Article CXXVII. | 52/82 | 77/max. |
| Relative humidity | 4/80 | | 0/82 | | |
| (min./max.), (%) | 29/35 | Article CXXVI. | 27/34 | Article CXXVIII. | Article CXXI |
| Temperature | | 8/34 | | 7/34 | 7/34 |
| (min./max.) (° C.) | | | | | |

[symbol]

indicates data missing or illegible when filed

TABLE 4
Average Pipe-Cross Reactor Surface Temperature (Thermocouple) Profile

| | Pipe-Cross Reactor Temperature Profile (° C.) | | | | | |
|---|---|---|---|---|---|---|
| | 45.7 cm | | 121.9 cm | | 198.1 cm | |
| | From Cross | | From Cross | | From Cross | |
| | Top | Bottom | Top | Bottom | Top | Bottom |
| EXAMPLE | Temp. 1 | Temp. 2 | Temp. 3 | Temp. 4 | Temp. 5 | Temp. 6 |
| 1 | 70 | 60 | 122 | 124 | 114 | 116 |
| 2 | 75 | 65 | 123 | 118 | 116 | 120 |
| 3 | 85 | 103 | 120 | 123 | 110 | 112 |
| 4 | 45 | 47 | 118 | 121 | 114 | 109 |
| 5 | 80 | 105 | 113 | 126 | 135 | 130 |
| 6 | 80 | 102 | 123 | 122 | 128 | 125 |
| 7 | 70 | 60 | 112 | 95 | 122 | 121 |
| 8 | 66 | 75 | 85 | 95 | 102 | 103 |
| 9 | 82 | 105 | 106 | 122 | 123 | 124 |
| 10 | 78 | 102 | 118 | 125 | 124 | 130 |
| 11 | 78 | 102 | 104 | 112 | 118 | 114 |
| 12 | 78 | 114 | 110 | 120 | 120 | 122 |
| 13 | 83 | 118 | 114 | 122 | 112 | 120 |
| 14 | 83 | 120 | 118 | 124 | 118 | 122 |

TABLE 5
Chemical Analysis of NPK Grade Fertilizer Product Samples

| | NPK Chemical Analysis (%) | | | | | |
|---|---|---|---|---|---|---|
| | Nitrogen | | P₂O₅ | | | Sulfur |
| EXAMPLE | Ammoniacal | As Nitrate | Water Soluble | Citrate Soluble | K₂O | As Sulfate |
| 1 | 6.4 | 5.1 | 11.2 | 1.6 | 8.0 | 8.0 |
| 2 | 6.9 | 5.2 | 9.9 | 1.4 | 17.2 | 8.7 |
| 3 | 7.1 | 4.9 | 10.5 | 1.2 | 16.3 | 9.0 |
| 4 | 7.0 | 5.2 | 9.4 | 1.1 | 17.5 | 9.0 |
| 5 | 7.6 | 4.9 | 9.0 | 3.6 | 16.5 | 7.9 |
| 6 | 7.0 | 4.9 | 8.6 | 3.9 | 16.3 | 7.2 |
| 7 | 9.7 | 4.5 | 11.4 | 1.2 | 14.9 | 10.2 |
| 8 | 10.0 | 4.5 | 11.5 | 2.5 | 15.1 | 7.9 |
| 9 | 10.2 | 4.4 | 13.1 | 2.5 | 14.6 | 8.3 |
| 10 | 10.0 | 5.2 | 12.7 | 1.9 | 17.4 | 6.9 |
| 11 | 10.4 | 4.8 | 14.6 | 1.9 | 16.1 | 6.9 |
| 12 | 15.8 | 1.8 | 15.8 | 2.0 | 12.2 | 12.2 |
| 13 | 16.1 | 1.6 | 16.6 | 2.2 | 5.4 | 12.2 |
| 14 | 15.6 | 1.6 | 16.2 | 2.3 | 5.2 | 12.4 |

TABLE 6
Particle Size Distribution, Size Guide Number (SGN) and
Uniformity Index (UI) of Representative Product Samples

| | Cumulative % Retained | | | | | | | |
|---|---|---|---|---|---|---|---|---|
| | on Screen (Screen Size (mm)) | | | | | | | |
| EXAMPLE | 4.00 | 3.35 | 2.80 | 2.36 | 2.00 | 1.70 | SGN | UI |
| 1 | 45.6 | 70.1 | 89.3 | 98.5 | 99.9 | 99.9 | 393 | 51 |
| 2 | 38.0 | 62.1 | 83.2 | 96.7 | 99.5 | 99.6 | 367 | 51 |
| 3 | 28.7 | 55.7 | 77.4 | 89.2 | 96.2 | 98.4 | 349 | 48 |
| 4 | 49.3 | 72.6 | 91.1 | 99.1 | 99.9 | 99.9 | 402 | 51 |
| 5 | 22.4 | 48.8 | 75.6 | 94.5 | 100.0 | 100.0 | 333 | 54 |
| 6 | 28.7 | 57.5 | 81.0 | 96.9 | 99.9 | 99.9 | 352 | 55 |
| 7 | 44.8 | 68.7 | 86.0 | 96.9 | 99.5 | 99.5 | 394 | 49 |
| 8 | 28.1 | 55.4 | 79.8 | 95.7 | 99.8 | 99.9 | 347 | 54 |
| 9 | 6.5 | 19.4 | 42.3 | 76.8 | 97.5 | 98.5 | 262 | 56 |
| 10 | 31.7 | 59.1 | 81.4 | 96.7 | 99.9 | 100.0 | 357 | 53 |
| 11 | 21.2 | 47.8 | 73.6 | 91.4 | 99.4 | 99.9 | 330 | 53 |
| 12 | 29.1 | 53.7 | 77.2 | 93.4 | 99.6 | 100.0 | 345 | 51 |
| 13 | 38.5 | 62.8 | 82.6 | 94.5 | 99.8 | 100.0 | 371 | 49 |
| 14 | 36.3 | 60.9 | 80.8 | 93.8 | 99.6 | 99.9 | 365 | 49 |

TABLE 7
Physical Properties of Representative Product Samples

| | | | | Bulk | Critical |
|---|---|---|---|---|---|
| | Abrasion | | | Density | Relative |
| | Resistance | Crushing Strength | | (Loose | Humidity |
| | % | (Kg/granule) | | Pour) | Range (%) |
| EXAMPLE | Degradation | Average | Range | (Kg/m³) | at 30° C. |
| 1 | 0.5 | 1.1 | 0.70-1.45 | 943 | 70-75 |
| 2 | 1.8 | 0.8 | 0.50-1.45 | 936 | 70-75 |
| 3 | 0.5 | 2.1 | 0.70-2.25 | 990 | 70-75 |
| 4 | 0.4 | 2.8 | 2.00-3.95 | 963 | 70-75 |
| 5 | 0.1 | 2.0 | 1.05-1.75 | 1,047 | 70-75 |
| 6 | 0.2 | 1.7 | 0.85-2.35 | 1,042 | 70-75 |
| 7 | 2.0 | 0.8 | 0.45-1.25 | 892 | 70-75 |
| 8 | 0.2 | 1.5 | 1.05-1.85 | 978 | 70-75 |
| 9 | 0.2 | 2.1 | 1.45-2.80 | 1,007 | 70-75 |
| 10 | 0.2 | 1.7 | 0.45-2.95 | 1,001 | 70-75 |
| 11 | 0.1 | 2.1 | 1.40-3.00 | 1,014 | 70-75 |
| 12 | 0.2 | 2.5 | 1.50-3.75 | 969 | 65-70 |
| 13 | 0.2 | 2.7 | 1.50-4.00 | 971 | 70-75 |
| 14 | 0.1 | 2.9 | 1.55-4.75 | 980 | 70-75 |

TABLE 8
Moisture Absorption-Penetration of Representative Product Samples
Moisture Holding Capacity

| | Moisture | Moisture | Moisture Holding | | |
|---|---|---|---|---|---|
| | Absorption | Penetration | Capacity | | Granule Integrity of |
| | (mg/cm²) | (cm) | (mg/cm³) | (%) | Wetted Area |
| 1 | 118.5 | 3.0 | 39.5 | 4.0 | Good |
| 2 | 63.4 | 2.5 | 25.4 | 2.6 | Good |
| 3 | 112.9 | 2.5 | 45.2 | 4.3 | Good |
| 4 | 85.4 | 2.0 | 42.7 | 4.2 | Good |
| 5 | 90.9 | 3.0 | 30.3 | 2.8 | Good |
| 6 | 93.7 | 2.0 | 46.9 | 4.3 | Good |
| 7 | 107.4 | 2.5 | 43.0 | 4.4 | Fair |
| 8 | 148.8 | 3.0 | 49.6 | 4.9 | Fair |
| 9 | 104.7 | 2.0 | 52.3 | 4.9 | Fair |
| 10 | 118.5 | 3.0 | 39.5 | 3.8 | Fair |
| 11 | 159.8 | 3.0 | 53.3 | 4.5 | Fair |
| 12 | 165.3 | 3.5 | 47.2 | 4.4 | Fair |
| 13 | 126.7 | 2.5 | 50.7 | 4.7 | Good |
| 14 | 223.1 | 3.5 | 63.7 | 6.0 | Good |

TABLE 9
Flowability of Representative Product Samples

| | Flowability | | |
|---|---|---|---|
| | (Minutes at 30° C. and 90 wt % Relative Humidity) | | |
| | | 50 wt % | |
| EXAMPLE | 25% Nonflowable | Nonflowable | 75% Nonflowable |
| 1 | 67 | 116 | 140 |
| 2 | 86 | 131 | 156 |
| 3 | 100 wt % Free Flowing After 150 Minutes | | |
| 4 | 100 wt % Free Flowing After 150 Minutes | | |
| 5 | 117 | 127 | 131 |
| 6 | 120 | 130 | 133 |
| 7 | 100 wt % Free Flowing After 150 Minutes | | |
| 8 | 100 wt % Free Flowing After 150 Minutes | | |
| 9 | 119 | 141 | 147 |
| 10 | 134 | 151 | 162 |
| 11 | 136 | 161 | 173 |

| | |
|---|---|
| 12 | 100 wt % Free Flowing After 150 Minutes |
| 13 | 100 wt % Free Flowing After 150 Minutes |
| 14 | 100 wt % Free Flowing After 150 Minutes |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A fertilizer composition comprising:
a) a fertilizer comprising a nitrogen compound, a phosphorus compound, a sulfur compound, and one or more potassium compounds, wherein one of the one or more potassium compounds is potassium oxide, and
b) a filler, wherein the filler comprises single superphosphate or triple superphosphate or a combination thereof.

2-7. (canceled)

8. The fertilizer composition of claim 1, wherein the fertilizer comprises nitrogen in the range of from 10 wt % to 20 wt %; P₂O₅ in the range of from 10 wt % to 20 wt %; K₂O in the range of from 5 wt % to 18 wt %; and sulfate in the range of from 5 wt % to 15 wt %.

9. The fertilizer composition of claim 1, wherein the fertilizer composition does not comprise potassium chloride or potassium sulfate.

10. The fertilizer composition of claim 1, wherein the fertilizer composition comprises an ammoniacal nitrogen source or a nitrate nitrogen source.

11. The fertilizer composition of claim 10, wherein the fertilizer composition comprises an ammoniacal nitrogen source that comprises monoammonium phosphate-based ammoniacal nitrogen, diammonium phosphate-based ammoniacal nitrogen, or ammonium sulfate-based ammoniacal nitrogen, or a combination thereof.

12. The fertilizer composition of claim 1, wherein the fertilizer composition comprises a phosphate source.

13. The fertilizer composition of claim 12, wherein the phosphate source comprises a monoammonium phosphate-based phosphate or diammonium phosphate-based phosphate, or a combination thereof.

14. The fertilizer composition of claim 1, wherein the fertilizer composition comprises calcium sulfate or ammonium sulfate or a combination thereof.

15. The fertilizer composition of claim 1, comprising:
a) two or more nitrogen compounds, wherein two of the two or more nitrogen compounds are an ammoniacal nitrogen source and a nitrate nitrogen source,
b) one or more phosphorus compounds, wherein one of the one or more phosphorus compounds is a phosphate source,
c) one or more sulfur compounds, wherein one of the one or more sulfur compounds is calcium sulfate or ammonium sulfate,
d) potassium oxide, and
e) a filler, wherein the filler comprises single superphosphate or triple superphosphate or a combination thereof.

16. (canceled)

17. The fertilizer composition of claim 15, wherein the sulfur compound is calcium sulfate.

18. The fertilizer composition of claim 1, further comprising a micronutrient.

19. The fertilizer composition of claim 1, wherein the fertilizer composition does not comprise diammonium phosphate (DAP).

20. (canceled)

21. The fertilizer composition of claim 1, wherein the fertilizer composition does not comprise gypsum.

22. (canceled)

23. (canceled)

24. The fertilizer composition of claim 1, wherein the fertilizer composition is substantially free of chlorine.

25. The fertilizer composition of claim 1, wherein the fertilizer composition comprises a trace element in an amount ranging from 1 wt % to 15 wt % based on the total fertilizer composition, wherein the trace element comprises iron, zinc, copper, or manganese, or a combination thereof.

26. (canceled)

27. The fertilizer composition of claim 1, wherein the single superphosphate or triple superphosphate is different than the phosphorus compound or the one or more phosphorus compounds.

28-36. (canceled)

37. The fertilizer composition of claim 1, comprising
monoammonium phosphate-based NPK Grade 12-12-17 fertilizer,
diammonium phosphate-based NPK Grade 12-12-17 fertilizer,
monoammonium phosphate-based NPK Grade 15-15-15 fertilizer,
diammonium phosphate-based NPK Grade 15-15-15 fertilizer,
diammonium phosphate-based NPK 16-16-16 Grade fertilizer, or
diammonium phosphate-based NPK 18-18-5 Grade fertilizer.

38. A method for producing a fertilizer composition of claim 1, wherein the fertilizer composition comprises ammonium sulfate comprising the steps of:
a) supplying a mixture of sulfuric acid and phosphoric acid; and
b) adding ammonia and phosphate rock to the mixture, thereby forming single superphosphate or triple superphosphate or a combination thereof and in-situ ammonium sulfate.

39. (canceled)

40. The method of claim 38, wherein the in-situ ammonium sulfate is from 80 wt % to 100 wt % of the ammonium sulfate in the fertilizer composition.

41. The method of claim 38, wherein the formation of the in-situ ammonium sulfate generates an amount of heat operable to produce a set of conditions in a granulator to produce a granule with a diameter ranging from 2 mm to 4.5 mm in size.

42-85. (canceled)
